(19) United States
(12) Patent Application Publication
(10) Pub. No.: US 2014/0060347 A1
(43) Pub. Date: Mar. 6, 2014

(54) Universal Recycling & Disposal Machine (URDM)

(71) Applicant: Javad Sahebkar Yazdi, Dubai (AE)

(72) Inventor: Javad Sahebkar Yazdi, Dubai (AE)

(21) Appl. No.: 13/717,761

(22) Filed: Dec. 18, 2012

Related U.S. Application Data
(60) Provisional application No. 61/715,858, filed on Oct. 19, 2012.

(51) Int. Cl. B30B 15/08; B30B 9/12; B02C 23/02

(52) U.S. Cl. CPC B30B 15/08; B02C 23/02; B30B 9/12
USPC 100/39; 241/25; 241/101.2; 100/94; 100/117

(57) ABSTRACT

Universal Recycling Disposal Machine designed to recycle and dispose almost all daily Municipal Solid Wastes (MSW) that generated by homes, offices and public places which refer to trash/rubbish. Machine will maximize the delivery (Direct Delivery) of the clean materials (Recycled Materials) to re-production plants and minimize or eliminate the volume/weight of MSW which should be delivered to landfill. The main concept was to design a machine that can be fixed within every kitchen cabinet or kitchen area and to be used as a home appliance (Dimensions of machine are match with standard kitchen cabinet). Machine designed in a way to minimize the sound & dust pollution during recycling and disposal processes. All items after recycling will be washed and rinsed before storing in plastic bins. During disposal process, big particles of disposed items will be filtered to avoid drainage blockage and all FOG will be removed from water.

### BACKGROUND OF THE INVENTION

This invention relates to recycling, disposal and storage of the recyclable daily Municipal Solid Waste (MSW) at homes, offices and public places and more particularly to a machine for recycling, disposal, and storage of different recyclable items like glass, metal, plastic, paper/paperboard and other items or disposal of food waste and other organic materials. Machine has one recycling compartment, one disposal compartment and one storage compartment including several plastic bins for storing of different recycled items.

Since protection of environment become a major concern for all societies, therefore more proper and effective recycling of MSW which can start from each end users (Each homes, offices, public places) has become more important compare to current industrial recycling. As we knew recycling has many benefits including saving energy, reducing air and water pollution, reducing greenhouse gas emissions, reducing waste products in landfills & saving land space, saving money, creating new jobs and preserving habitat for wildlife.

Although current industrial recycling methods has many disadvantages which create so many barriers for more and effective recycling of MSW. Based on EPA statistics Americans generated 250 million tons of MSW in 2010 and only 65 million tons of this MSW has been recovered and more than 136 million tons discarded. Industrial recycling (Curbside recycling) is costly. Municipalities, recycling companies and contractors should collect high volume and bulky wastes from millions of locations and transfer them to recovery facilities and spent lots of time and efforts to sort, clean and pack the materials for delivery to production facilities. Collection of 250 million tons of MSW alone is a big challenge and creates pollutions and emissions. Meanwhile major problem of collected MSW by municipalities is high level of contamination of wastes which needs lot of efforts for sorting, washing, cleaning, compaction and delivery to reproduction facilities. All these processes consume lots of energy and again create pollution and emission. Due to mixture of different wastes, recovery sometimes is difficult and even impossible therefore reduce the amount of recovery and increase the discarding on landfill. Furthermore recycling of these highly contaminated materials will be more costly and therefore recovered materials will be expensive and sometime recycling will become unfeasible.

However recycling and disposal at the point of consumption (Homes, Offices, Public Places) will be more easier, more effective, much less contaminated or no contamination, more value for recycled materials (Since sorted better and cleaned), less costly, lees number of collections by authorities (monthly instead of daily) and direct delivery to reproduction facilities without necessity of delivery to recovery facility centers for sorting, washing, cleaning and compaction and redelivery to reproduction facilities. Recycling at point of consumption with accurate sorting (e.g. PET, LDPE, Alum, Colored and plain glass cullet) has higher values and makes reproduction much easier.

### BRIEF SUMMARY OF THE INVENTION

So with attention to the above facts related to industrial recycling, recycling at homes, offices, public places will become more important. The invention will recycle almost 100% of normal daily trash and wastes (MSW) at the point of consumption. All items which have been sorted by user like plastic, glass, aluminum/metal, paper/paperboard and other recyclable items will be recycled, washed, rinsed, compacted and stored in bins.

All food wastes and organic items will be grinded to small particles and disposed/drained to drainage system. To avoid blockage of drainage system, big particles of disposed items will be filtered and could be removed and delivered to landfill. Disposing system will remove the FOG (Fat, Oil & Grease) from water and clean water will be drained to drainage system.

The main objective of present invention to reduce the size, volume and weight of MSW and therefore deliver the minimum dried materials (Food wastes and organic materials) to landfills and also deliver sorted and cleaned recycled materials (plastic, glass, metal, alum, paper/paper board, textile and other inorganic materials) directly to reproduction facilities. This will illuminate millions daily truck travels to landfill and material recovery centers and reduces pollution and emission dramatically. Less delivery to landfills will reduce the landfill sizes and number of landfills in each area. Energy consumption for sorting, cleaning and compaction at material recovery facilities will be reduced and only big item like furniture, home appliances, electronic items or materials which are not part of daily normal MSW will be recycled at these centers.

Another objective of the invention, to have an recycling appliance at home or office (In Kitchen or Pantry Area) for instant recycling and disposal. All items could be sorted, recycled, washed, rinsed, compacted and stored in predefined plastic bins for long time without having any smell or odor. Sorting can be done with maximum accuracy based on the specification mentioned on each item like PET, PE, LDPE, Green Glass, Brown Glass, Aluminum, etc by end user. Machine will allow user to define the recycling process/program based on category (Plastic, Metal, Etc.), subcategory (Plastic/PET, Metal/Alum, etc.) and material itself for more efficient recycling. Recycled materials have usually ⅕ to 1/10 of their initial size/volume therefore for example 40 recycled PET bottles (1 ltr.) or more can be stored easily in one of the plastic bins (assigned by user to PET material) inside the machine. Meanwhile disposing can be done at the same time with other compartment of machine. Disposal compartment will ease the disposal quickly and very effectively therefore the weight, size and volume of disposed materials will be reduced up to 70% of initial weight, size and volume (Water is the main part of food scrapes).

Remaining big particles in disposal filter only will be removed and delivered to landfills. Based on EPA statistics 35 million tons of food wastes generate in US in 2010. Present invention could dispose major parts of food wastes and reduce the weight and volume of delivery to municipality collection trucks and subsequently landfills and discarding volumes.

Third objection of present invention is to make recycling at home and office easier and faster as majority of people does not want to spend time to sort and dispose the wastes at the consumption or disposal points.

Fourth and another major objective of invention will be the production of clean and compacted recycled materials ready to be delivered directly to production facilities and factories. This will create an opportunity to sell the recycled materials to private companies or getting subsidies from municipality and authorities. As much as end users sort and recycle the materials, municipality and authorities' civil costs for recycling will be reduced a lot therefore municipality will be ready to give incentives to people to recycle more. Currently municipality and energy authorities will give such an incentive to customers for less consumption of water/electricity or gas. Private recycling companies also are ready to buy the high quality cullet or alum. Recycled materials which are ready for reproduction rather than purchasing of materials that need lots of works for reproduction. Machine will be connected to internet and volume of recycling/disposing can be measured and recorded and authority can even monitor the machine operation remotely for any subsidizing purposes.

It is a further objective of invention to provide several plastic bins on a rotating table of storage compartment. Each bin can be assigned to different recycled materials by user and each bin can be accessed through a Skip Button on main panel for easy emptying.

### Machine Description

Universal Recycling Disposal Machine designed to recycle and dispose almost all daily Municipal Solid Wastes (MSW) that generated by homes, offices and public places which refer to trash/rubbish.

Machine includes three major compartments as follow:
A—Recycling Compartment
B—Recycling Collection/Storing Compartment
C—Disposal Compartment

The idea was to design a machine that can be fixed within every kitchen cabinet or pantry area and to be used as home appliance. Therefore the dimensions of machine are match with standard kitchen cabinet (Mainly Height & Dept of cabinet).

Three major factors have considered in the design of machine.
Weight of Machine: Since the major parts and compartments of machine are heavy then total weight of machine will be around 170-185 kg and machine need to work under heavy shocks as well therefore strong chassis required to support the major parts and components and handle the heavy shocks.
Noise: Recycling and disposal process are noisy and create loud sound. Therefore machine designed in a way to minimize the sound pollution and bring the noise level to 80 dBA or lower.
Dust & Dirt: Most of the daily MSW are contaminated and need to be washed after recycling. Food's cans, tubes, glasses, bottles, paper & paperboards, etc. contains the dirt or remaining of contents. All items after recycling will be washed and rinsed for storing in plastic bins. Meanwhile recycling process (Crushing, shredding) create dust therefore this dust need to be exhausted and filtered properly. Machine's design allows proper wash, rinse and dewatering of recycled items plus proper ventilation of created dust. Meanwhile big particles of disposed items, will be filtered to avoid drainage blockage and all FOG will be removed from water (Used for washing of recycled items or disposal process) so clean water will be drained to drainage system as well.

So generally Universal Recycling and Disposal Machine will recycle most of our daily MSW, which sorted by user and then wash/rinse and finally store them in designated bins for direct delivery to production process. Recycling process will reduce the size and volume of the materials up to 10 times or more (Depend on the materials) and will able us to keep our clean garbage for longer time without necessity of daily delivery to municipality collection system.

### BRIEF DESCRIPTION OF DRAWINGS

FIG. 1 Machine Full Assembly with Main Parts drawing (Front View)

FIG. 2 Machine Chassis (Perspectives of frames and connection pieces).

FIG. 3 Insulation Mat Fixing Detail drawing

FIG. 4 Acoustic Foam Absorption with Sound Barrier Layer Fixing Detail drawing.

FIG. 4a Acoustic Foam & Absorption Sound Barrier Coefficient chart

FIG. 5 Stainless Steel Feeding Hooper drawing (Views, Perspective & dimensions)

FIG. 6 Exhaust Fan & Filter Views & Dimensions

FIG. 7 Water Spray Nozzle drawing (View & Specification Table)

FIG. 8 Solenoid Valve drawing (Views, Section, Dimensions)

FIG. 8a Solenoid Valve drawing (View, Details of Water Supply Rubber Hose Connections to Tab & Spray Nozzles)

FIG. 9 Water Supply Diagram drawing (View, Perspective & Details of water supply line/pipe to Spray Nozzles & Solenoid Valve)

FIG. 10 Micro Diaphragm Liquid Dosing Pump drawing (Views, Dimensions)

FIG. 10A Micro Diaphragm Liquid Dosing Pump specifications

FIG. 11 Liquid Dispenser & Feeding Compartment drawing (Views, Details, Dimensions)

FIG. 12 Crusher/Shredder Compartment & Motor Chassis drawing (Views & Dimensions)

FIG. 13 Crusher/Shredder Compartment & Motor Chassis detail drawing (Views, Connection Details and Dimensions)

FIG. 14 Crusher/Shredder Chamber/Main Housing drawing (Views, Dimensions)

FIG. 15 Cutter Cartridge & Blades Design drawing (Views, Detail, Dimensions)

FIG. 16 Blade Design drawings (View, Detail, Dimensions)

FIG. 17 Cleaning Blades drawing (Perspective)

FIG. 18 Cleaning Blades Design drawing (Views, Dimensions)

FIG. 19 Hexagonal Drive Shaft drawing (Views, Perspective, Details)

FIG. 20 Hexagonal Driven Shaft drawing (View, Perspective, Details)

FIG. 21 Drive Gear drawing (Views, Perspective & Dimensions)

FIG. 22 Driven Gear drawing (Views, Perspective & Dimensions)

FIG. 23 Gear Basic Design drawing (Definitions & Basics of Design)

FIG. 24 Bearing Flanged Unit & Mechanical Seal for End & Thru Shafts drawing (Views, Section, Details & Dimensions)

FIG. 25 Spur Gears Design drawing (Views, Section, Details & Dimensions)

FIG. 25a Spur Gears Specifications

FIG. 26 Gearmotor/Speed Reducer for Crusher/Shredder Compartment drawing (Views, Details & Dimensions)

FIG. 26a Gearmotor/Speed Reducer for Crusher/Shredder Compartment specifications

FIG. 27 Connection Chamber drawing (Views & Dimensions)

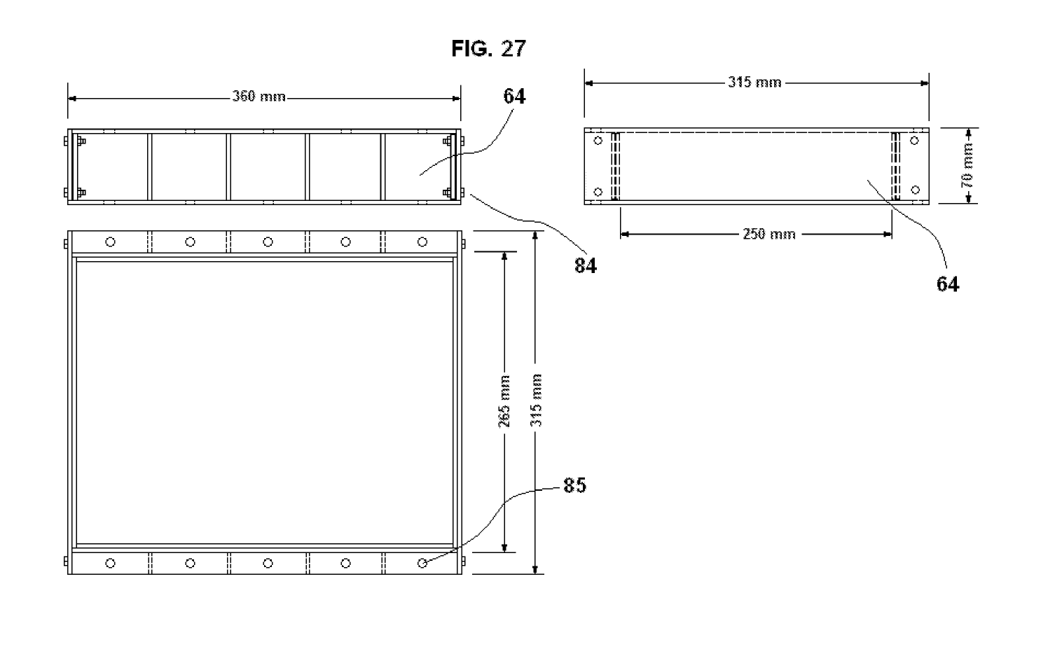

FIG. 28 Crusher/Shredder Chamber & Motor Assembly drawing (View, Details & Dimensions)

FIG. 29 Shaft Mounted Helical Gearmotor & Reducer drawing (Views, Dimensions)

FIG. 29a Shaft Mounted Helical Gearmotor & Reducer specifications

FIG. 30 Crusher/Shredder Chamber & Motor Assembly drawing Option II (View, Section, Dimensions)

FIG. 31 Compactor Chamber/Main Housing drawing (Top View, Dimensions)

FIG. 32 Compactor Chamber/Main Housing drawing (Side View, Dimensions)

FIG. 33 Compactor Chamber/Main Housing drawing (Front View, Dimensions)

FIG. 34 Compactor Chamber/Main Housing drawing (Back View, Dimensions)

FIG. 35 Compactor Auger Design drawing (View, Dimensions)

FIG. 36 Duplex Sprocket Gear (Drive Gear) drawing for Motor's Shaft (View, Section, Dimension)

FIG. 37 Duplex Sprocket Gear (Driven Gear) drawing for Auger's/Compactor Shaft (View, Section, Dimension)

FIG. 38 Duplex Chain drawing for Sprocket Gears (View, Perspective, Dimensions)

FIG. 39 Gearmotor/Speed Reducer for Compactor Compartment drawing (Views, Section & Dimensions)

FIG. 39a Gearmotor/Speed Reducer for Compactor Compartment specifications

FIG. 40 Compactor Chamber & Motor Chassis drawing (Views, Details & Dimensions)

FIG. 41 Dewatering Drain Pump & Motor drawing for Compactor Chamber (Views, Dimensions)

FIG. 41a Dewatering Drain Pump & Motor specifications

FIG. 42 Receiver Container drawing Round Shape Option I (Views, Details & Dimensions)

FIG. 43 Gas Traction Spring (Shock Absorber Gas Traction Spring) drawing for Compactor & Receiver Container (Views, Details, Dimensions)

FIG. 43a Gas Traction Spring specifications

FIG. 44 Actuator drawing for Receiver Container (Views, Details, Dimensions)

FIG. 44a Actuator for Receiver Container specifications

FIG. 45 Compactor Compartment Assembly drawing (Views, Details)

FIG. 46 Compactor Compartment, Motor & Actuator Assembly drawing (View, Dimensions)

FIG. 47 Receiver Container drawing Rectangular Shape Option II (Views, Details & Dimensions)

FIG. 48 Compactor Compartment Assembly drawing Option II (Views, Details)

FIG. 49 Compactor Compartment, Motor & Actuator Assembly drawing Option II (View, Dimensions)

FIG. 50 Recycling Collection/Storing Compartment Chassis drawing (Views, Dimension)

FIG. 51 Step Motor drawing (Views, Dimension)

FIG. 51a Step Motor specifications

FIG. 52 Rotating Table drawing (For Plastic Bins) (Views, Dimensions)

FIG. 53 Pulley for Step Motor & Rotating Table's shafts Design drawing (View, Section, Specification & Dimensions)

FIG. 54 Belt Design drawing for Pulleys (Views, Specification & Dimensions)

FIG. 55 Plastic Bins drawing (Views, Perspective, Dimensions)

FIG. 56 Recycling Compartment & Motor Assembly drawings (Views, Details, Dimensions)

FIG. 56a Top view of Recycling Compartment & Motor Assembly

FIG. 57 Stainless Steel Sink drawing (Top View, Dimensions)

FIG. 58 Stainless Steel Sink drawing without flange (Side View, Dimensions)

FIG. 59 Stainless Steel Sink drawing with flange (Side View, Details, Dimensions)

FIG. 60 Stainless Steel Sink & Sliding Door/Lid Assembly drawing (Views, Perspectives, Connection Details, Dimensions)

FIG. 61 Glass Door/Lid Grooves Details Detail drawing (Views, Perspective, Section & Dimensions)

FIG. 62 Disposal Motor On/Off Key drawing (Views, Dimensions)

FIG. 63 Typical Disposal Motor drawing (Perspective)

FIG. 64 Water Supply Diagram (To Sink) drawing (Perspective, View)

FIG. 65 Sink & Disposal Motor Assembly drawing (Perspectives, Dimensions)

FIG. 66 Solid Trap & Grease Interceptor drawing (Side View/Section & Dimensions)

FIG. 67 Solid Trap & Grease Interceptor drawing (Front View & Dimensions)

FIG. 68 Flow Control fitting drawing (Views, Dimensions)

FIG. 69 Machine Drainage Diagram drawing (View & Details)

FIG. 70 Drain Pump & Motor drawing for Solid Trap & Grease Interceptor (Views & Dimensions)

FIG. 70a Drain Pump & Motor for Solid Trap & Grease Interceptor specifications

FIG. 71 Recycling Collection/Storing Compartment Access Door drawing (Views, Dimensions)

FIG. 72 Machine Body Structure design drawing (Exploded Perspective)

FIG. 73 Machine Full Assembly & Main Parts drawing (Front View & External Dimensions)

### DETAILED DESCRIPTION

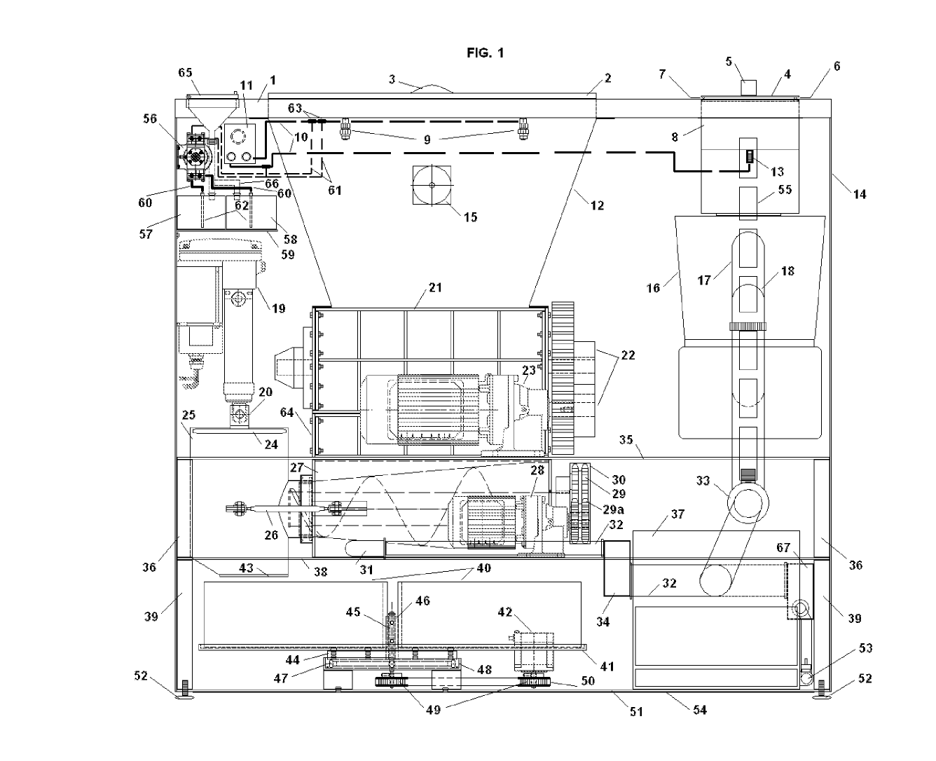

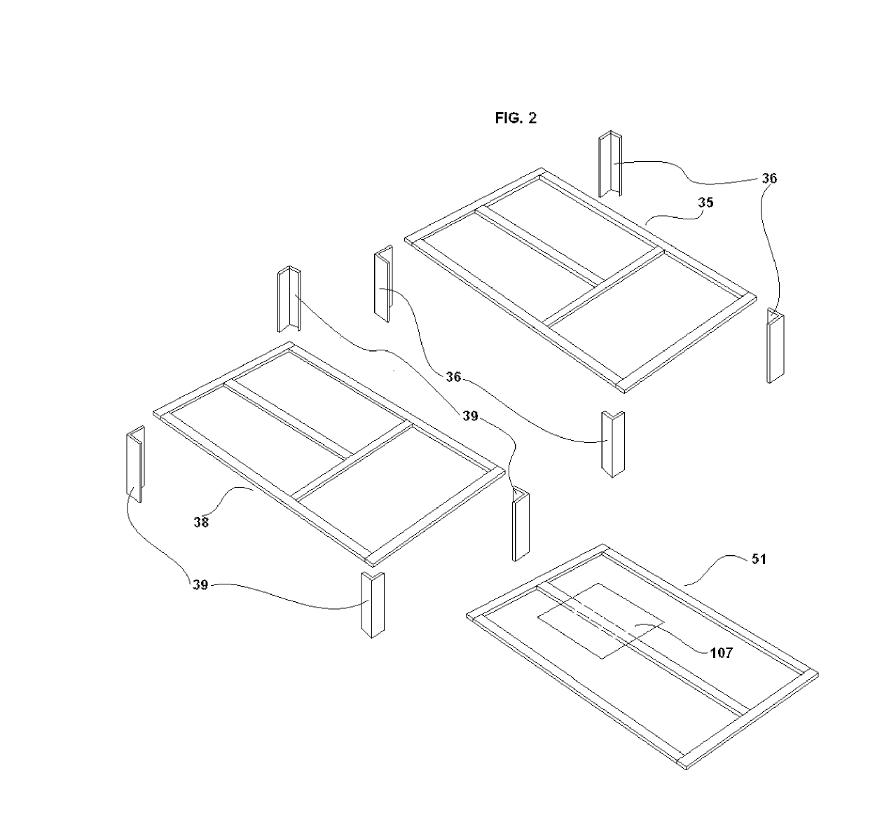

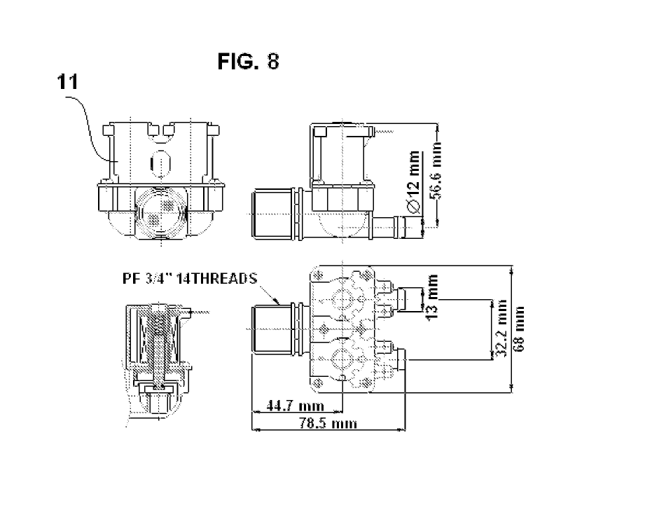

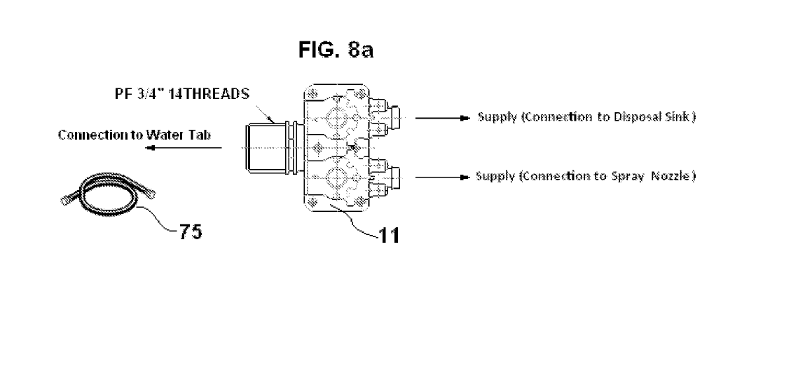

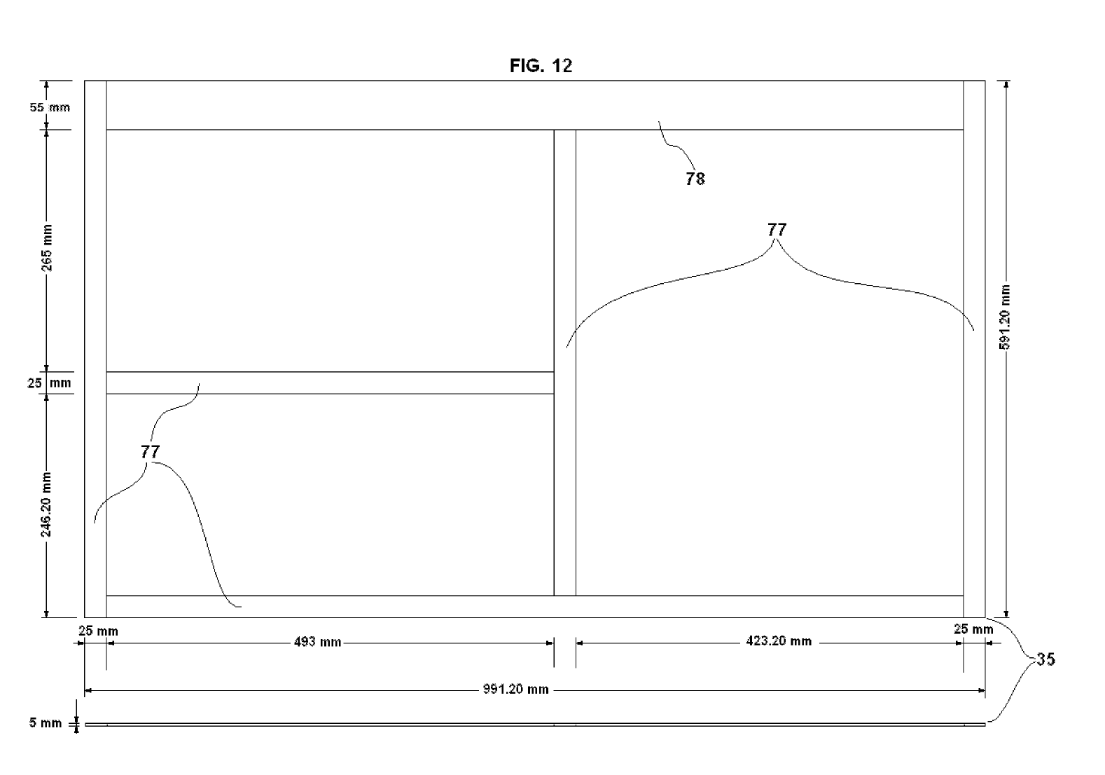

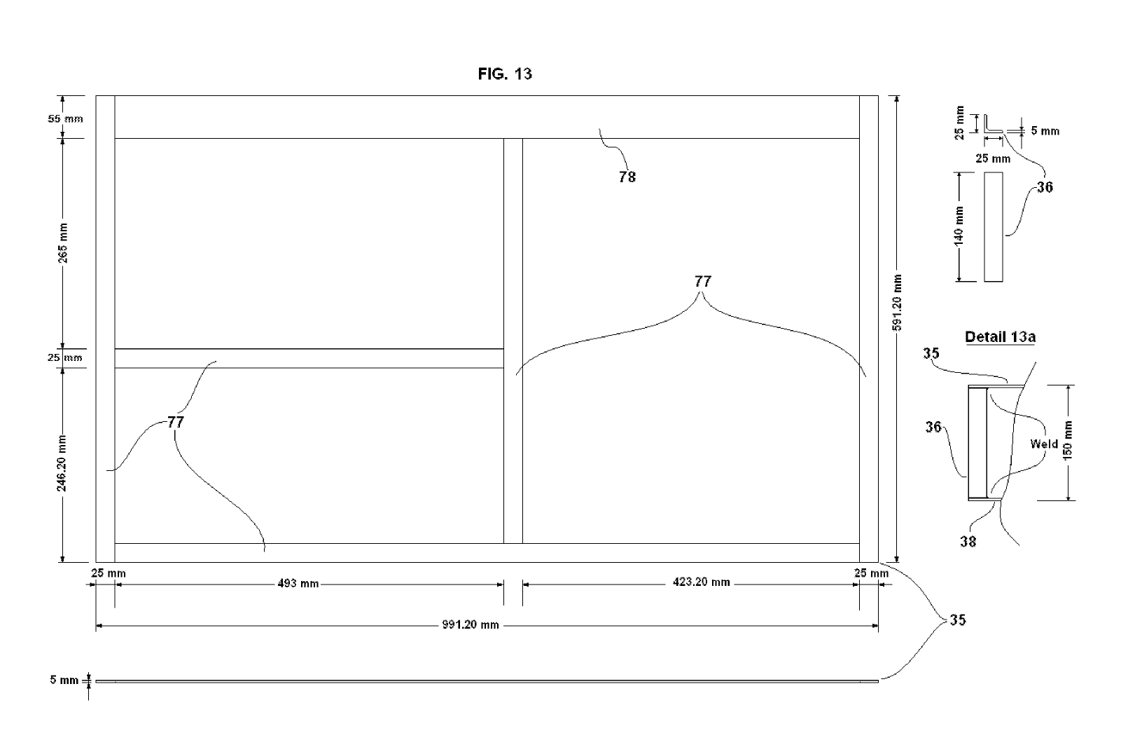

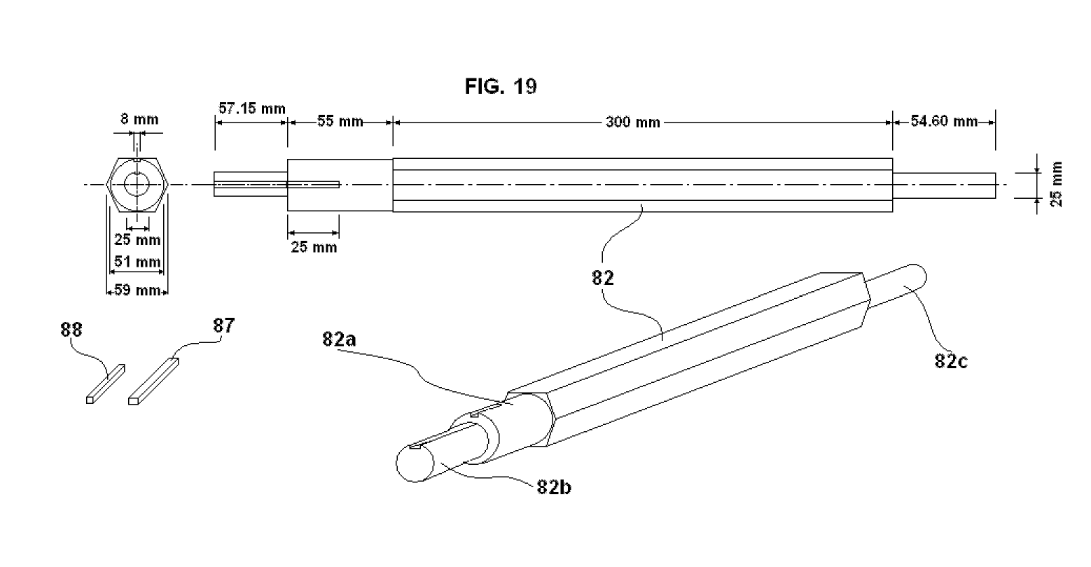

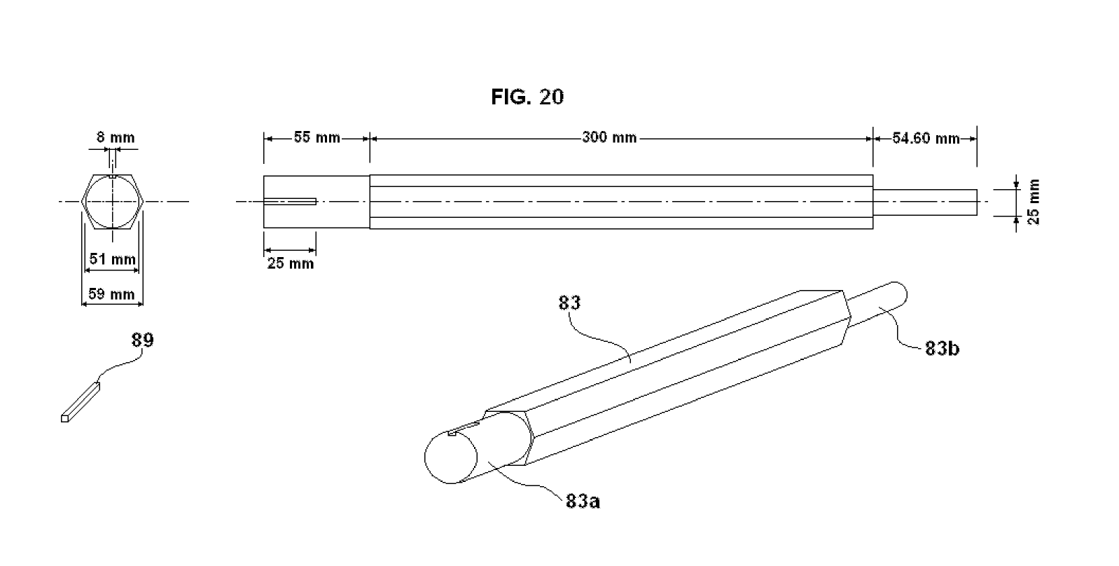

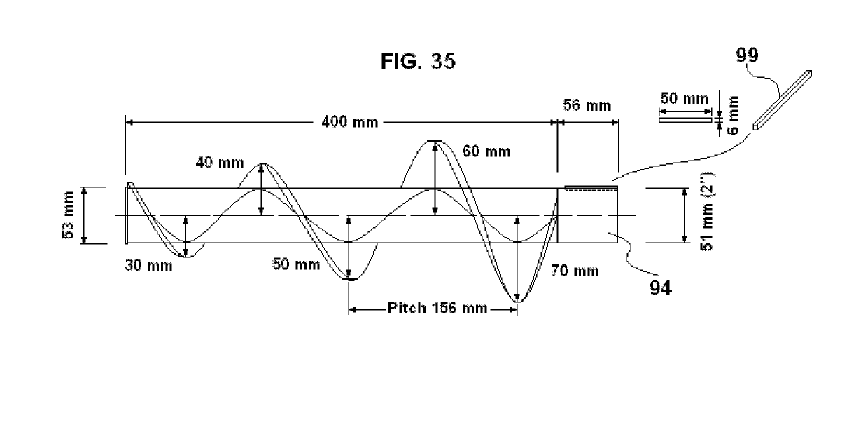

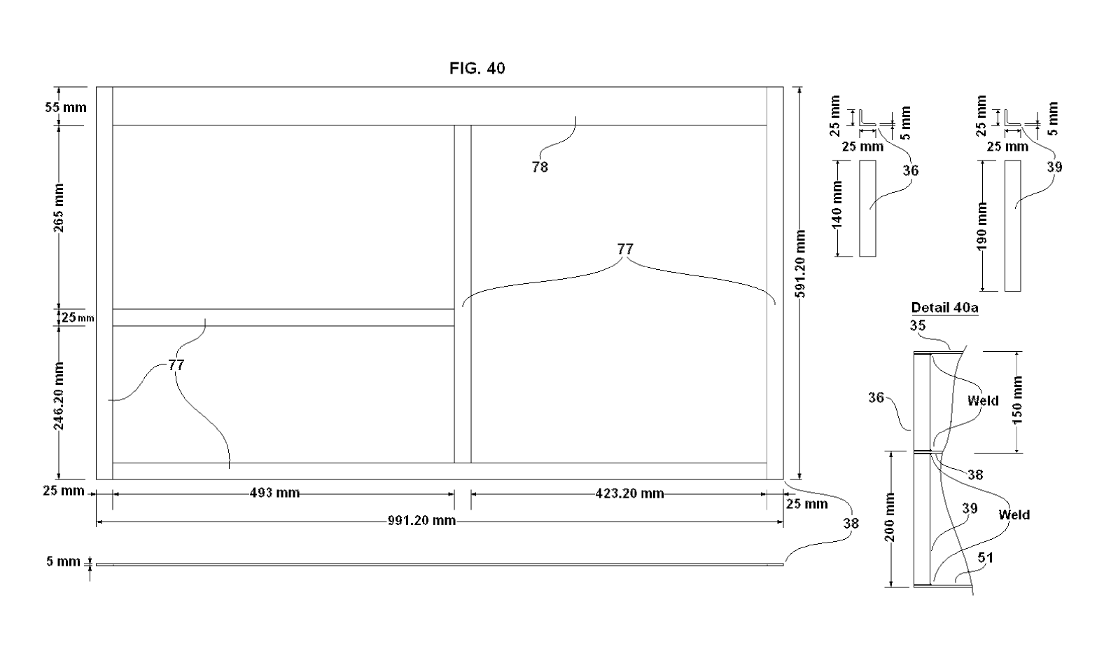

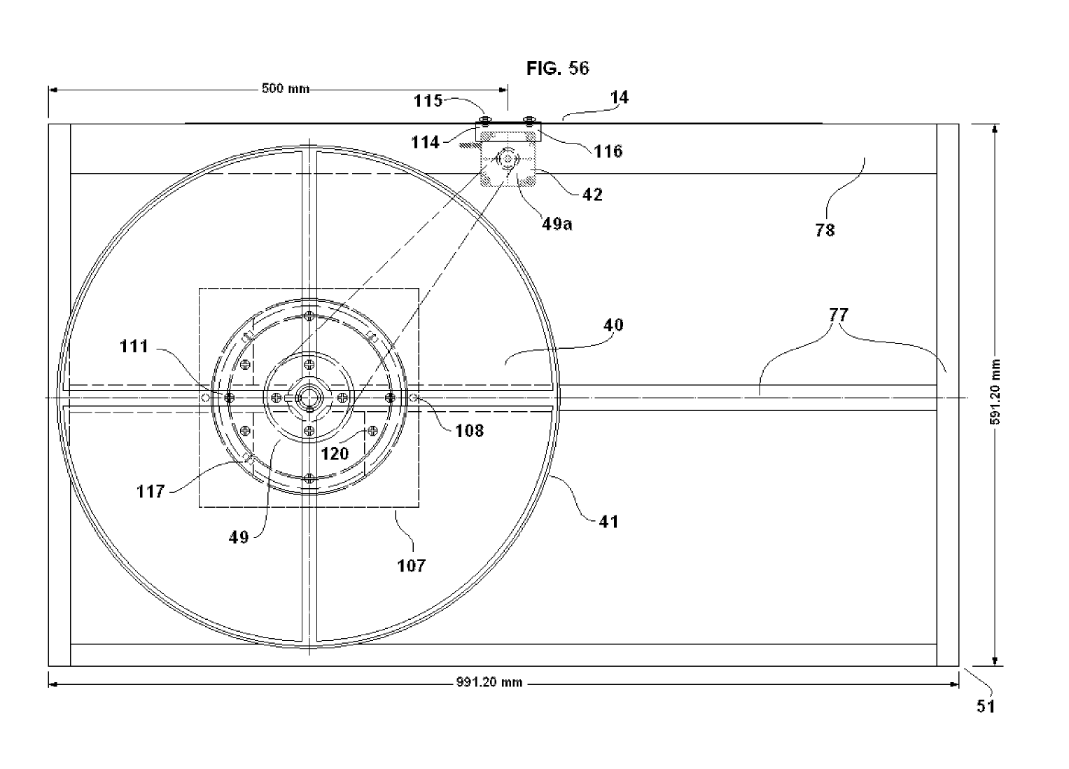

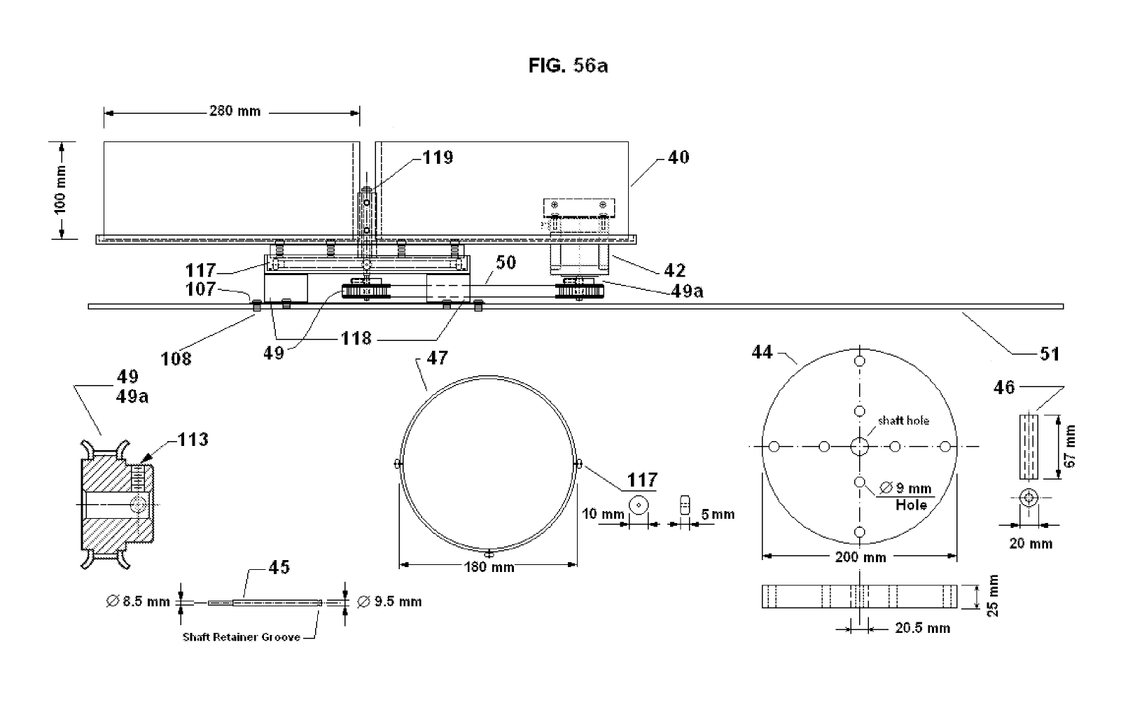

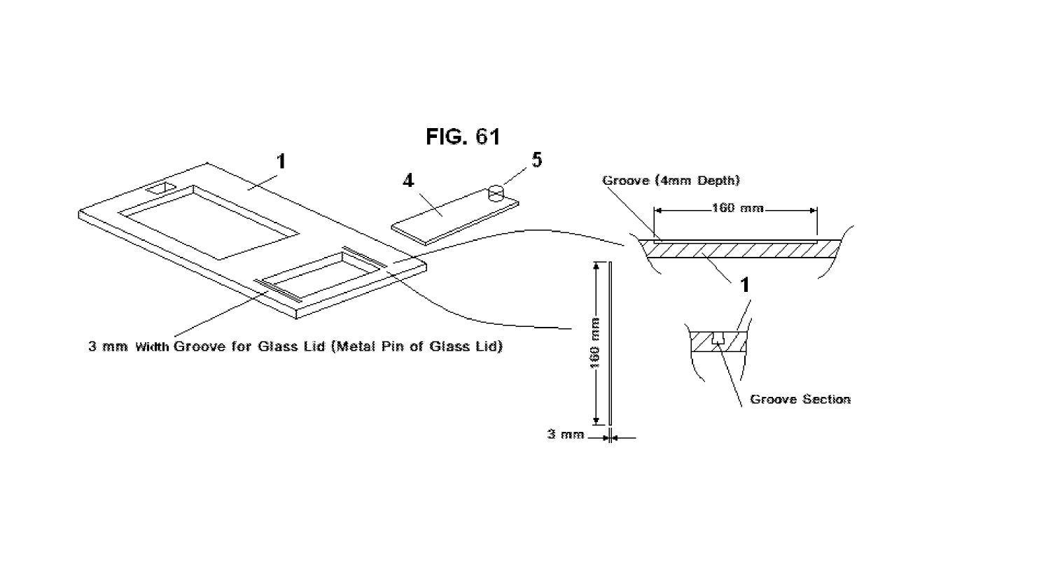

Machine FIG. 1 main parts and components are as follow: Machine Top Panel 1 to cover the top portion of machine with 3 openings for recycling compartment 1a, disposal compartment 1b & liquid feeding compartment 1c shown on FIG. 1, Recycling Compartment Access Door with lock 2 (Will be locked automatically during operation)(Bimetal door locks with unlocking delay) for feeding material to recycling compartment/feeding hopper 12, Access Door Handle 3 to ease the opening and closing of door, Glass Door (Sink Door/Lid) 4 (Tempered White Glass Sliding lid/Cutting Board) for covering of disposal stainless sink 8 and also can be used as cutting board for cutting of food wastes to smaller pieces or sizes, Metal (Stainless Steel)/Plastic Knob 5 (For sliding door/lid) to ease the closing and opening of the glass door/lid 4, Metal T shape pin 6 (Attached to glass lid) for better guidance of glass door/lid 4 on 3 mm grooves created on top panel 1. Details of grooves shown on FIG. 61, Metal/Rubber Round pin 7 (To ease the sliding and balancing of glass lid), Stainless Steel Sink 8 (Under-mount Stainless steel sink attached to disposal motor), Water Spray Nozzle 9 two (For washing of recycled materials), Plastic pipes 10 (Water supply pipe & fitting for connection of electric/solenoid valve 11 to Liquid Dosing Pump (Micro Diaphragm Liquid pump) 56, Nozzles 9 & Sink 8), Solenoid Valve 11(Electric Water Supply Valve) for supplying of water to Spray Nozzles and Sink during machine operation. Solenoid Valve will be connected by pressure rubber hose 75 to water tab FIG. 8a. Stainless Steel Feeding Hopper 12 (For Recycling Compartment), Sink Waterfall connection (Fitting) 13 to connect the water supply Plastic Pipe 10 to Sink 8, Machine External Body 14 (Metal sheet), Exhaust Fan & Filter 15 (For exhausting of dust during recycling to external ducting and filtering of big particles), Disposal Motor 16 (For grinding/disposing of food scraps and other organic materials), Plastic Drain Pipes 17 to connect the Disposal Motor to U Trap 16, Flow Control 33, Solid Trap & Grease Interceptor 37, Small Drain Pump 67 and at the end to exit drain point of machine, U Trap 18 for connecting of Plastic Drain Pipe 17 to Flow Control 33 to reduce the water speed after draining from Disposal Motor 16, Actuator 19 (Attached to compaction disk in Receiver Container) for compaction (2^{nd} compaction process) of the recycled materials feed to Receiver Container 25 from Auger Compaction chamber 27, Mounting Pin 20 (CF2 Clevis with pin) to connect the Actuator 19 to Compaction Disk 24 of Receiver Container 25, Crusher/Shredder Chamber 21 (Cast Iron Chamber), Gears 22 (for Torque & Power Transmission from Motor 23 to Crusher Shaft) (Two Pieces attached to Motor Shaft & Crusher Shaft FIG. 19 & FIG. 20), Motor/Speed Reducer 23 for Crusher/Shredder compartment, Compaction Disk 24 (attached to Actuator), Receiver Container 25 (Recycled Container for discharging to Plastic bins 40), Gas Traction Springs 26 (Two Pieces), Auger Compactor & Chamber 27 (Compaction, Washing, Rinsing Compartment/Chamber), Motor/Speed Reducer for Auger Compactor 28, Duplex Sprockets/Gears 29 & 29a for Chain 30 (For torque and power transmission from Motor 28 to Auger Shaft FIG. 35), Duplex Chain 30, Drain outlet/Fitting (Elbow) 31 (Compaction Chamber/compartment drain outlet), Plastic/Rubber Drain Pipe 32 (From Chamber 27 to Drain Pump 34), Flow Control 33, Drain Pump, Crusher/Shredder Compartment Support Frame 35 (Chassis FIG. 2, FIG. 12 & FIG. 13) (Steel Stripe), Steel Angles A 36 (25×25 mm)(Part of Chassis), Solid Trap & Grease Interceptor 37, Compactor Compartment Support Frame 38 (Chassis FIG. 2 & FIG. 40) (Steel Stripe), Steel Angles B 39 (25×25 mm)(Part of Chassis), Plastic Bins 40 (For storing of recycled items), Rotating Table 41 (Plastic Bins holder), Step Motor 42 (For rotating and positioning of Rotating Table 41 & Plastic bins 40 below discharge hatch 43 of Receiver Container 25), Discharge Hatch 43 (At Bottom of Receiver Container 25), Strengthen Plate 44, Shaft 45 (To connect the rotating table 41 to Belt Pulley 49), Bush 46 (Holding shaft bush), Roller Wheel 47, Supporting Plate 48 for Roller Wheel 47 & Rotating Table 41, Belt Pulleys 49 & 49a, Belt 50, Recycling Collection/Storing Compartment Support Frame 51 (Chassis FIG. 2, 50 & FIG. 56) (Steel Stripe), Screw Leg 52 (Machine adjustable legs), Drain Valve 53, Bottom Plate 54, Air Intake 55, Micro Diaphragm Liquid pump 56, Liquid Tank 1 57 (Liquid Dishwasher, Liquid Detergent), Liquid Tank 2 58 (Liquid Pipe Cleaner, Other Cleaning materials), Mounting Bracket/Support Plate 59 (For Liquid Tanks), Suction Tubing 60 (PVC), Delivery Tubing 61 (PE), Suction device with level probe 62, Injection Connector 63 (Stainless Steel), Connection (Middle) Chamber 64 (Between Crusher 21 & Compaction chambers 27), Liquid Dispenser Feeding Compartment 65, PVC Pipe 66 (Connection from Filling compartment 65 to Liquid Tanks 57 & 58), Small Drain Pump 67 (For Draining of water from Solid Trap & Grease Interceptor 37 during filter cleaning and changing).

Machine Chassis (Built and assembled from Steel Strips 77,78 & Steel Angles 36, 39) Shown on FIGS. 2, 12, 13, 39 & 50): Weight of machine will be more than 170 kg therefore machine body and chassis to be strong enough to support the compartments, parts and heavy shocks including crusher/shredder chamber 21, Motor & reducer of shredder 23, compactor chamber 27 & motor 28 and recycling Compartment bins 41 and motors 42. 50 & 25 mm width, 5 mm thickness steel stripes 78, 77 and angles 36,39 create a strong chassis 35, 38 & 51 for machine. Steel Angles 36 & 39 dimensions shown on FIG. 13 & FIG. 40. Crusher/shredder frame 35 connection to steel angles 36 & compactor frame 38 shown on Detail 13a. Compactor frame 38 connection to steel angles 39 and recycling compartment frame 51 shown on Detail 40a.

Sound insulation/barrier: Sound insulation mats 73 fixed on internal steel plate of machine body (all around).

The second major factor on design is sound. Recycling (crushing/shredding/compaction) process of different materials like metal, glass, wood and plastic create lots of noise therefore machine internal body and recycling compartment (Feeding hopper, crushing/shredding/compaction chambers) to be insulated properly to reduce the sound to an acceptable level. Two types of sound insulation materials have been considered for internal body of machine 14 and external surface of Feeding hopper 12, recycling chamber 21, compaction chamber 27, connection chamber 64 and disposal compartment.

Sound insulation material 73 (Type 1) applied on internal body of machine. Sound insulation mat should have similar or equal properties as follow:

Typical properties
Type: Mineral filled, polymer modified asphalt
Thickness: 0.125″ (3.2 mm)
Density: 98 lbs/ft3 (1570 Kg/m3)
Surface Density: 0.65 lbs/ft2 (3.2 Kg/m2)
Stiffness ASTM D 747: 28 kps (193 Mpa)
Cold Resistance—4° F. (−25° C.): No break
Tensile Strength: 36 psi (250 Kpa)
Flammability DOT MVSS 302: <75 mm/min—Pass
Shrinkage: <1%

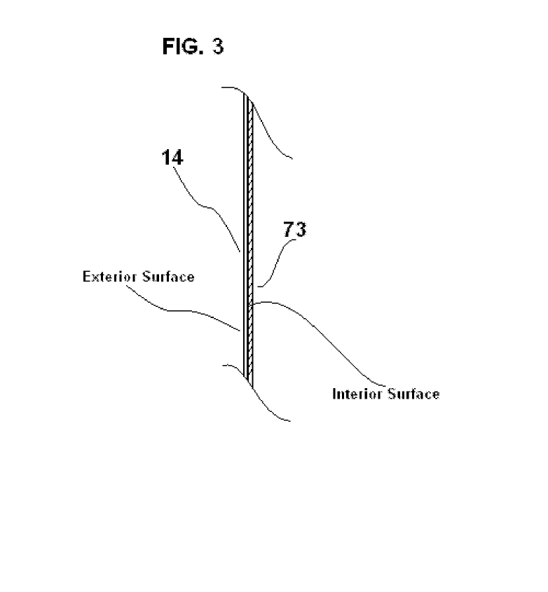

Sound insulation mat fixing detail shown on FIG. 3.

Sound insulation for feeding hopper, shredder & compactor chambers external surfaces (Type 2):

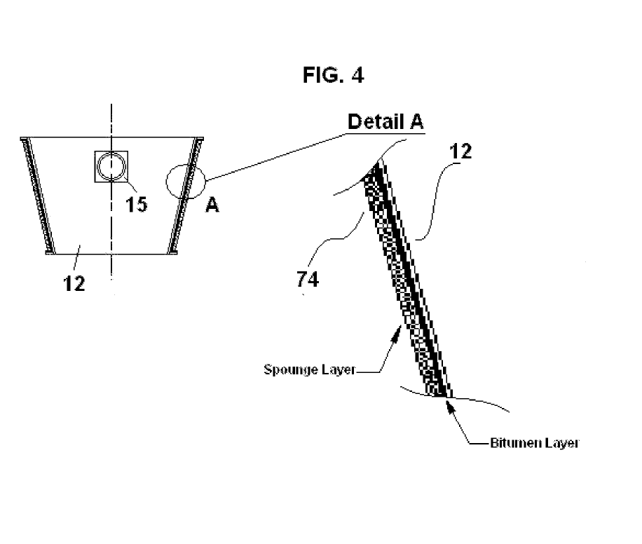

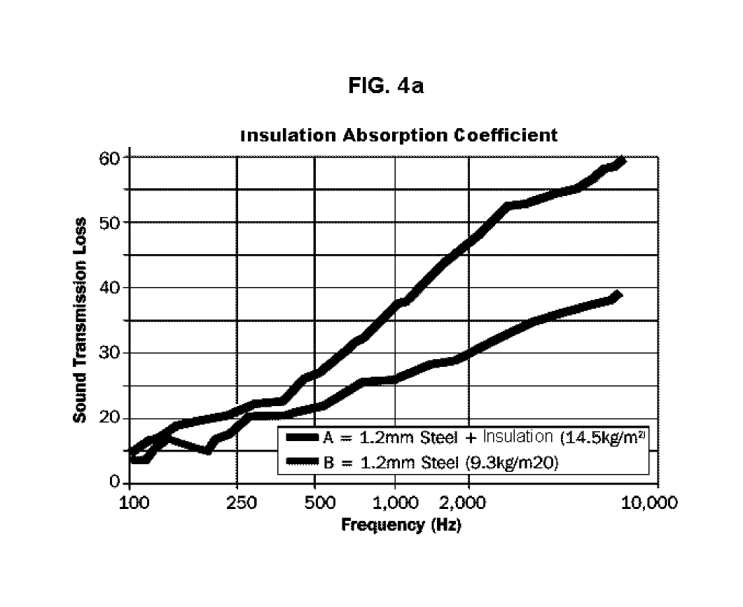

Acoustic foam absorption with a sound barrier layer 74 have been considered and these sound barrier mats are particularly useful for insulating hoppers 12 and machine enclosures (Shredder 21 & Compactor 27 exterior surfaces). This type spaced layer sound barrier mats employ self-extinguishing components and are primarily intended for the improvement of the sound insulation of sheet metal that resonates above 350 Hz. (FIG. 4a shows the effect of application of such insulation).

This material is similar with soundproofing mat except the sound barrier layer has a scratch resistant skin and the other side has a layer of sound absorbing acoustic foam. FIG. 4 shows fixing details and insulation material type 2.

A—Recycling System/Compartment

As mentioned the Universal Recycling & Disposal Machine includes three compartments which Recycling system/compartment is the core of the machine. This section will crush/shred, wash, compact and store materials in designated plastic rotary bins 40. Materials which could be recycled are mainly Paper/Paperboard, Plastics (PET, HDPE, LDPE, PE, PP, PS, etc.), Metals (Mainly metal & Alum cans and small metal items), Rubber/Leather/Textiles, Wood and Glass (Green, Brown, Colorless) although many other items could be recycled by this machine as well. After feeding the material into feeding hopper 12 and selection of material from control panel 68 by pushing the desired button 68b (e.g. plastic/PET), crusher/shredder compartment will crush/shred the items to very small pieces (Size could be reduced up to 1/10 or more depend on the material) and will automatically feed to connection chamber 64 and then to compactor chamber 27 for second process. In compactor chamber 27, material will be washed and rinsed (if required as per selected program) and then Auger will compact the shredded/crushed materials to max possible level and simultaneously dewatering any remaining water for discharging to receiver container 25 for another compaction process. Material will be feed automatically to receiver container 25 and a compaction disk 24 attached to actuator 19 will compact and discharge the recycled materials to collection bins compartment.

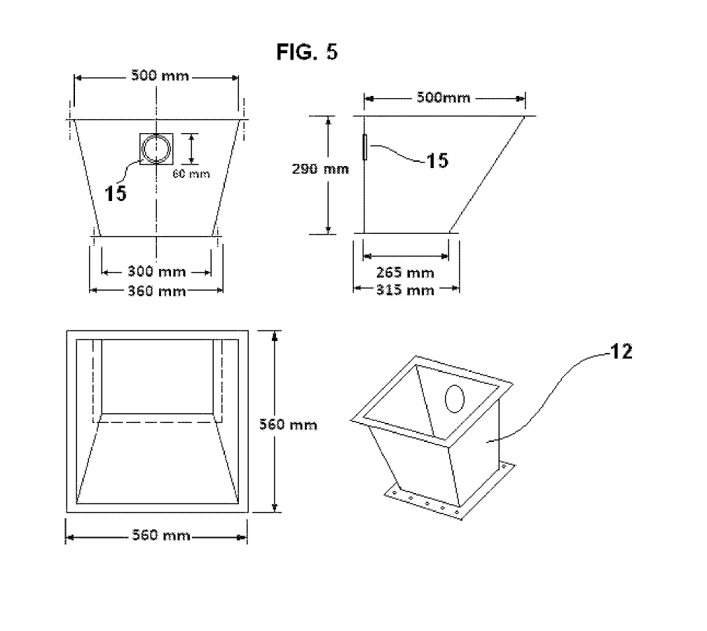

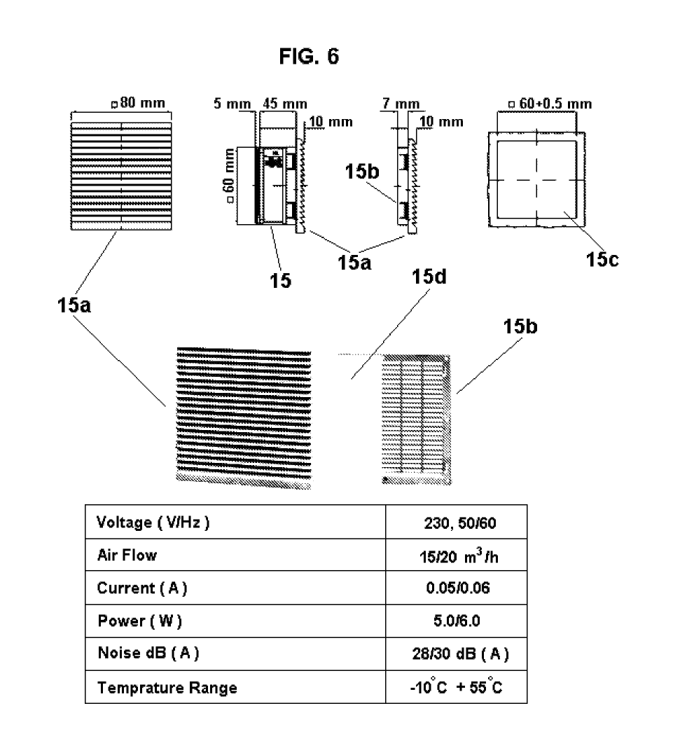

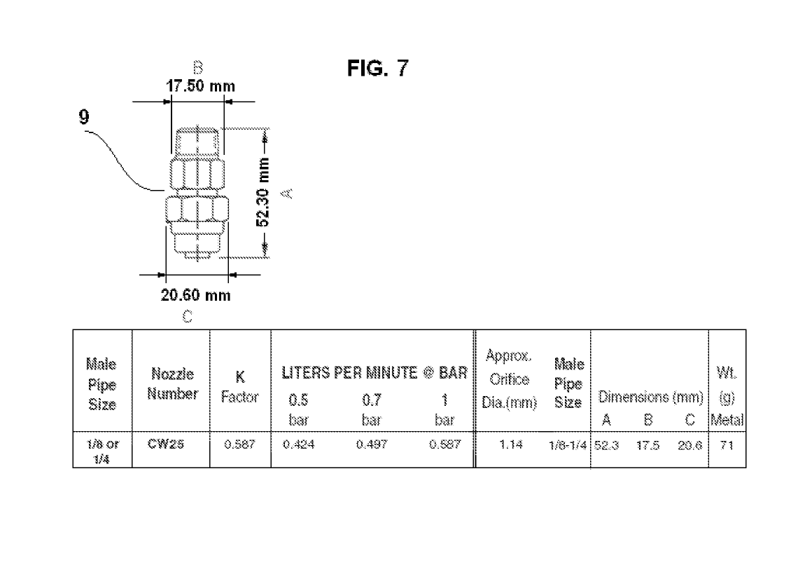

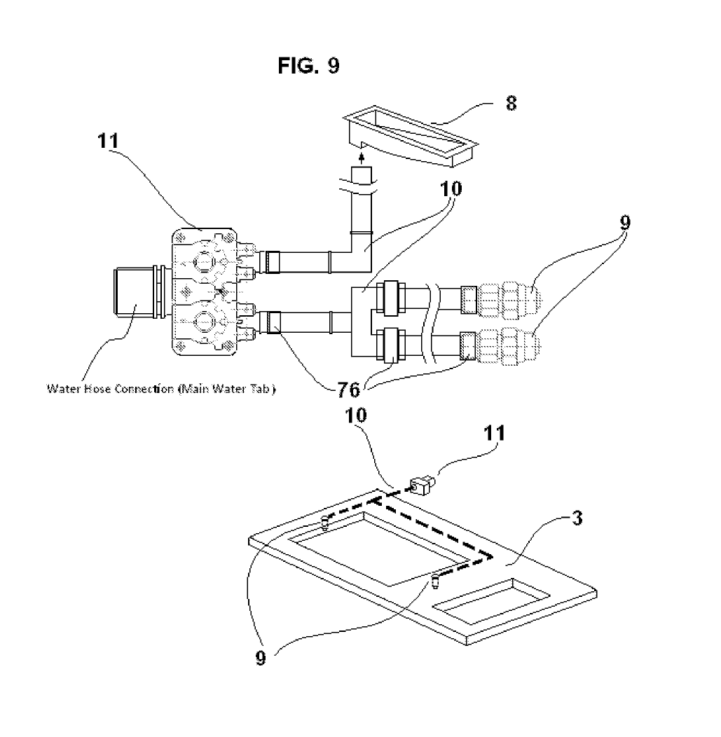

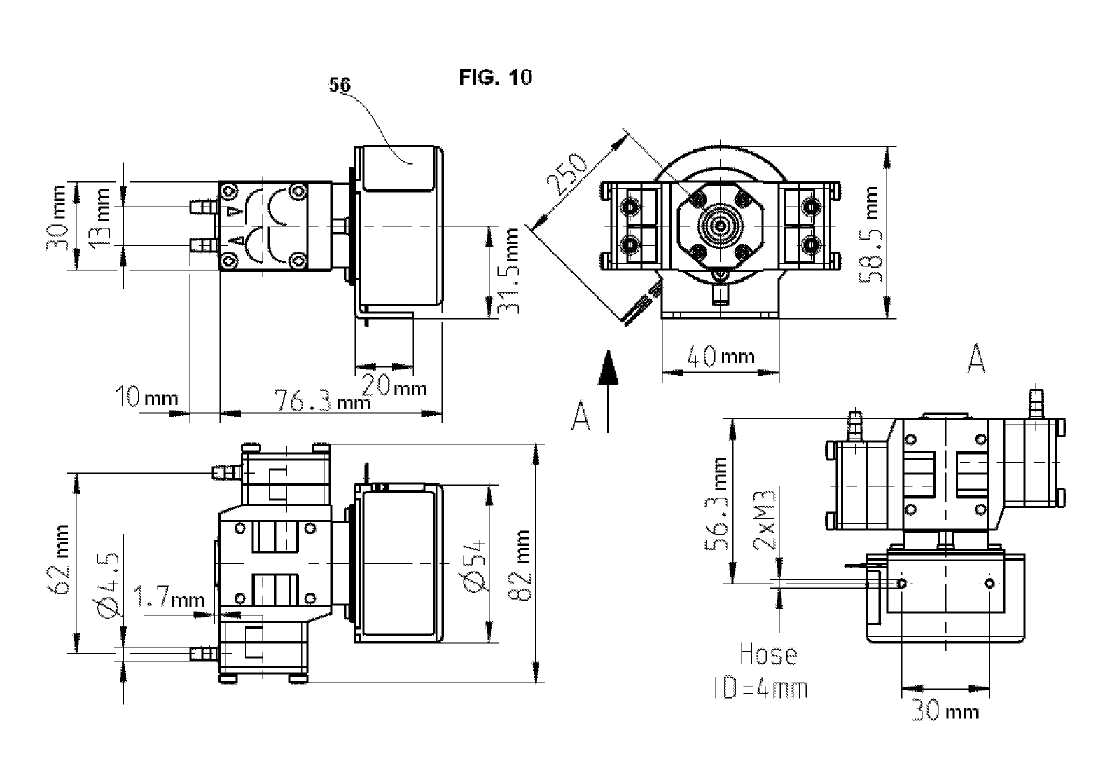

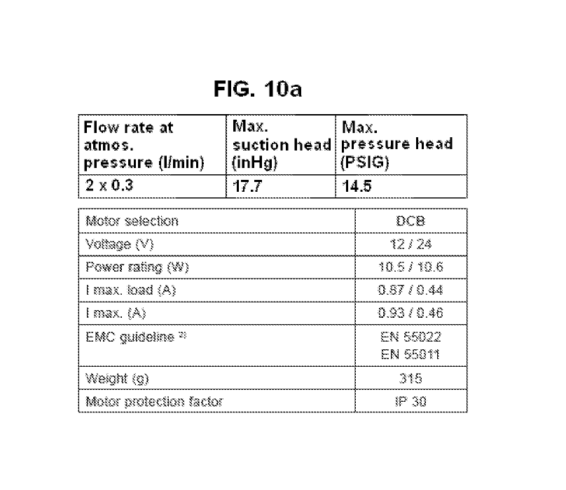

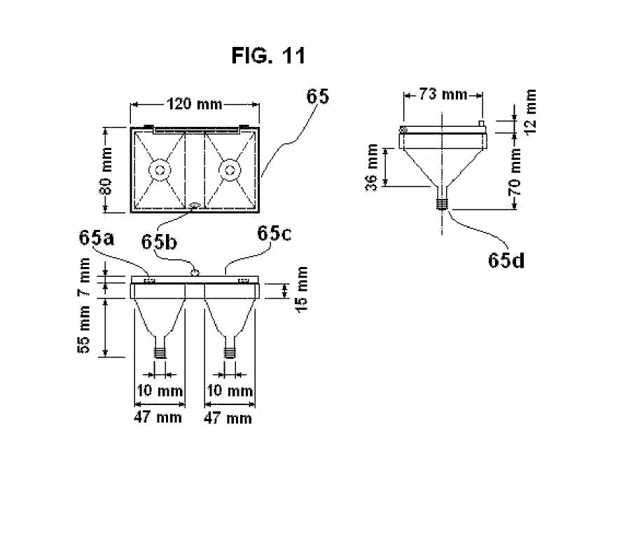

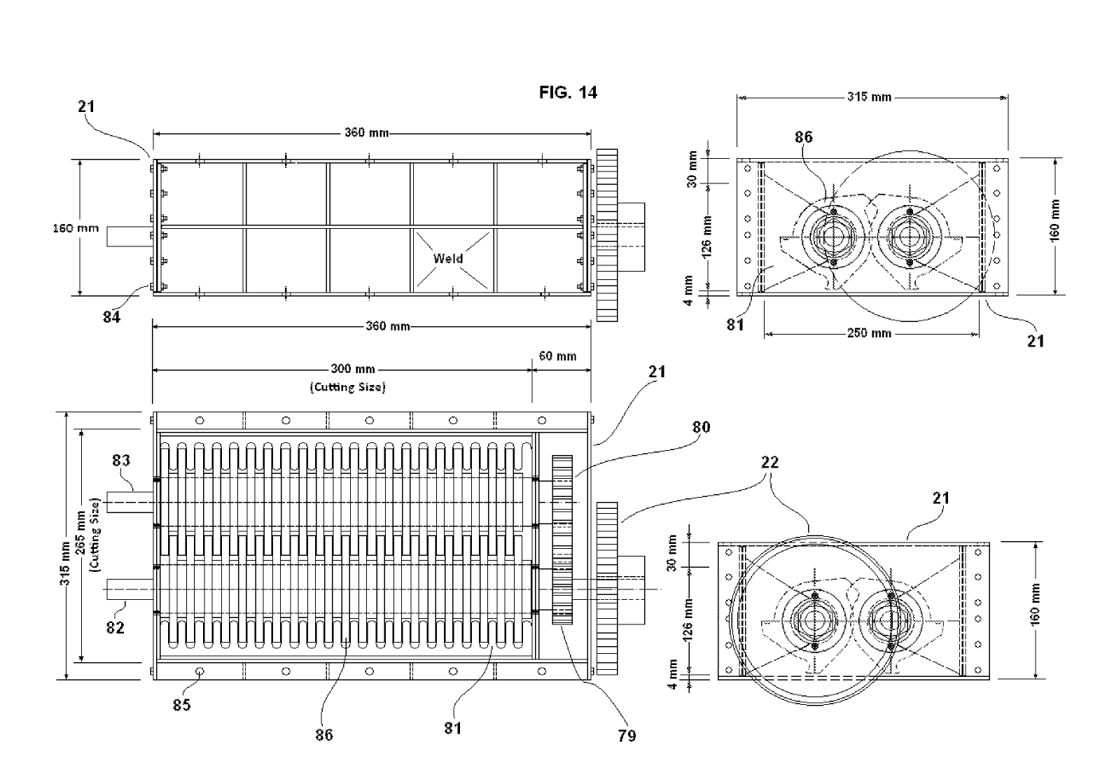

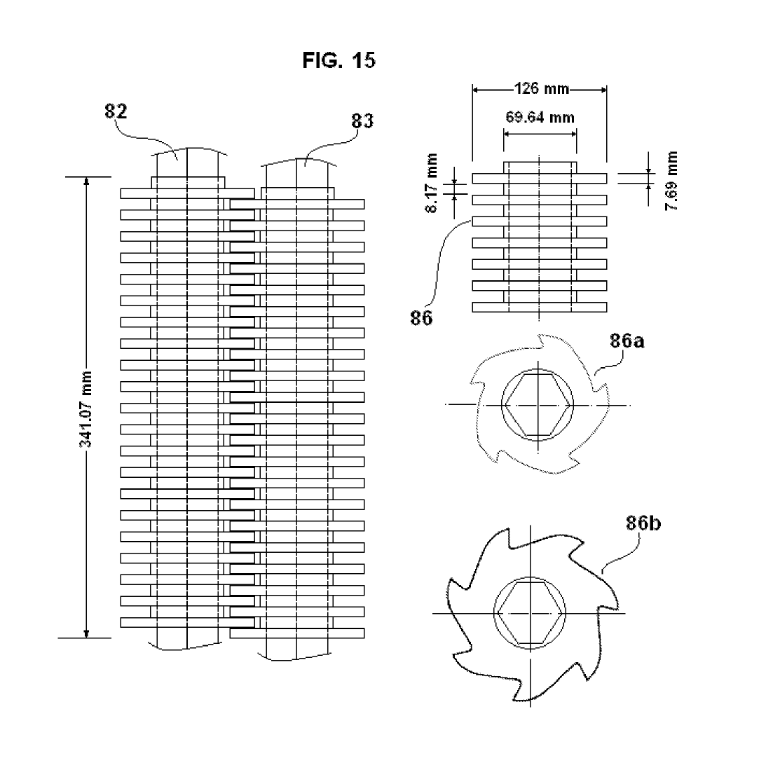

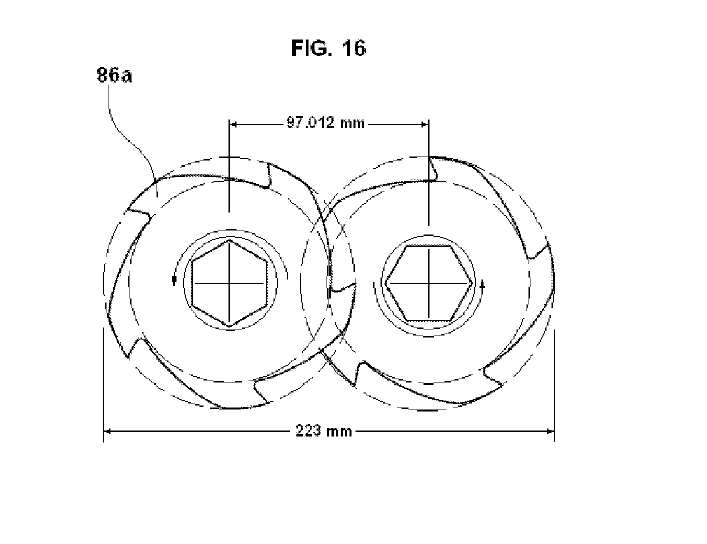

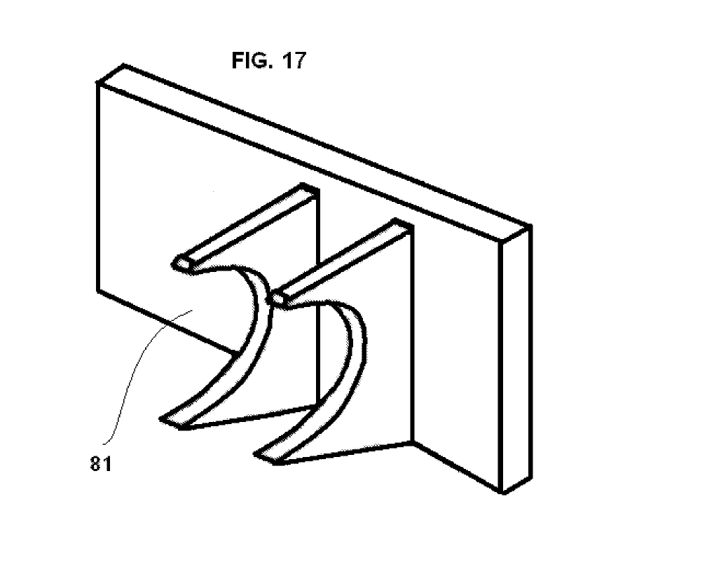

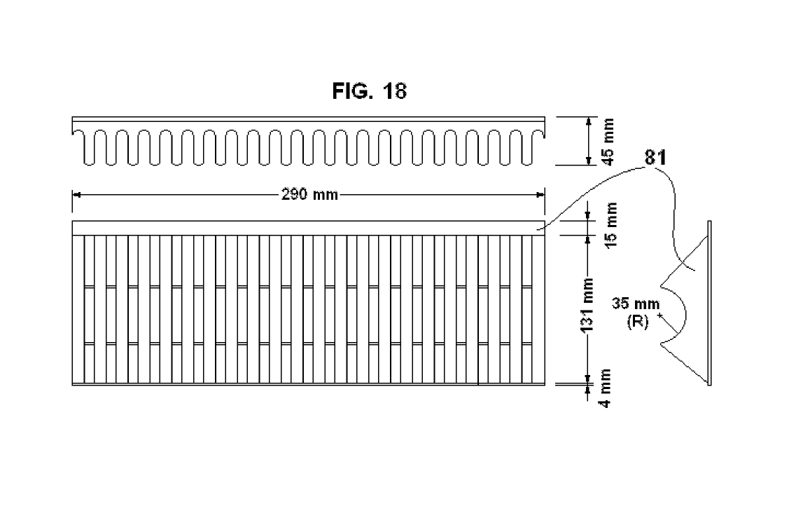

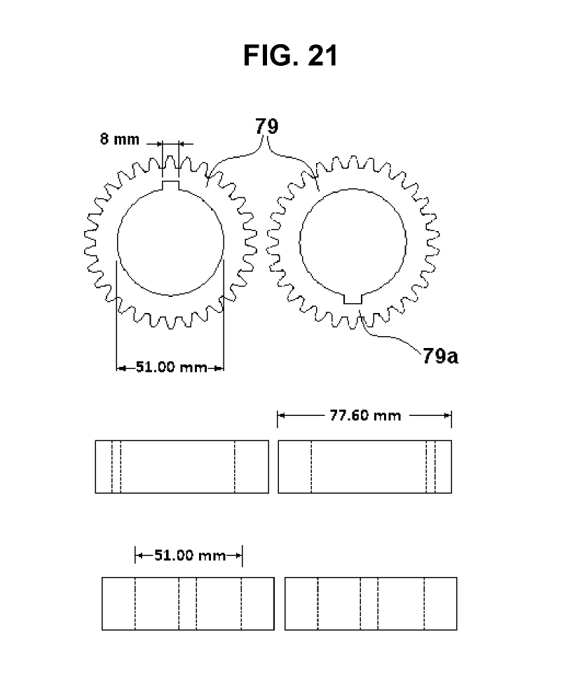

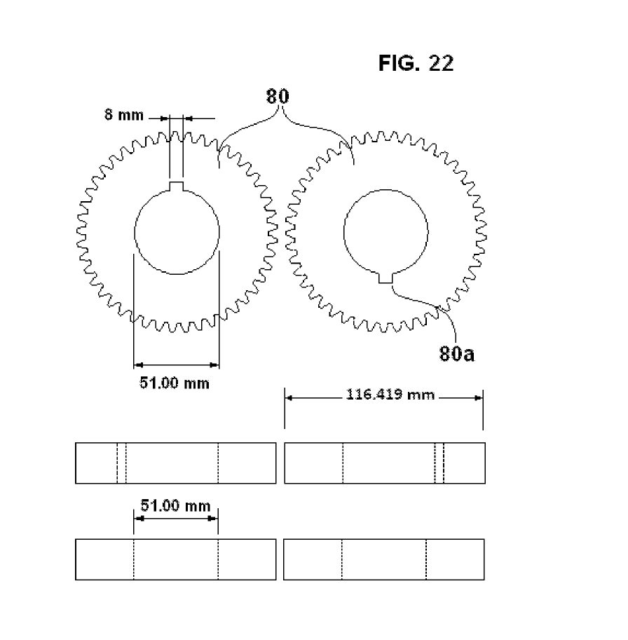

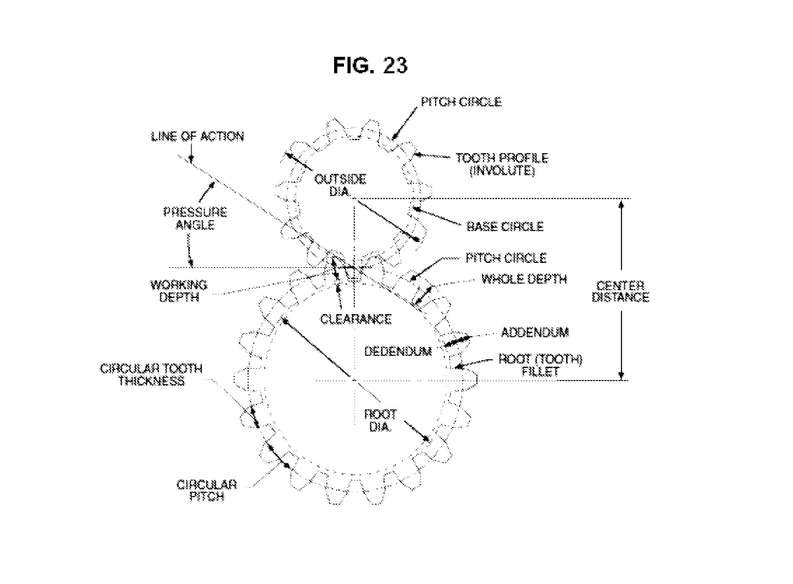

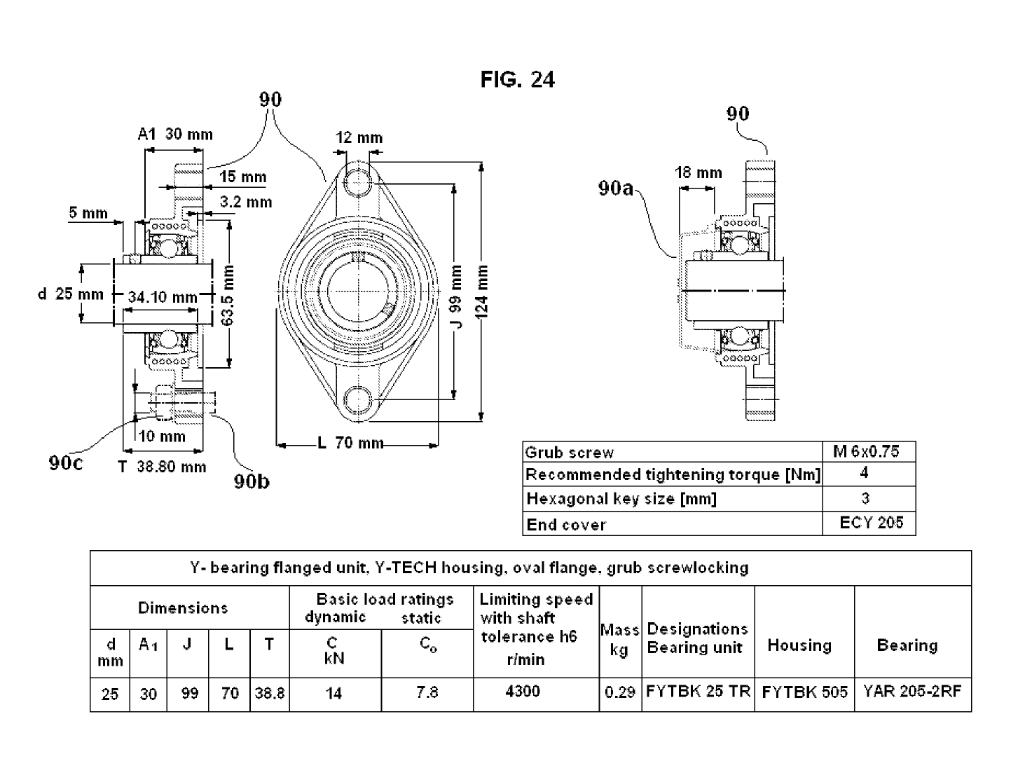

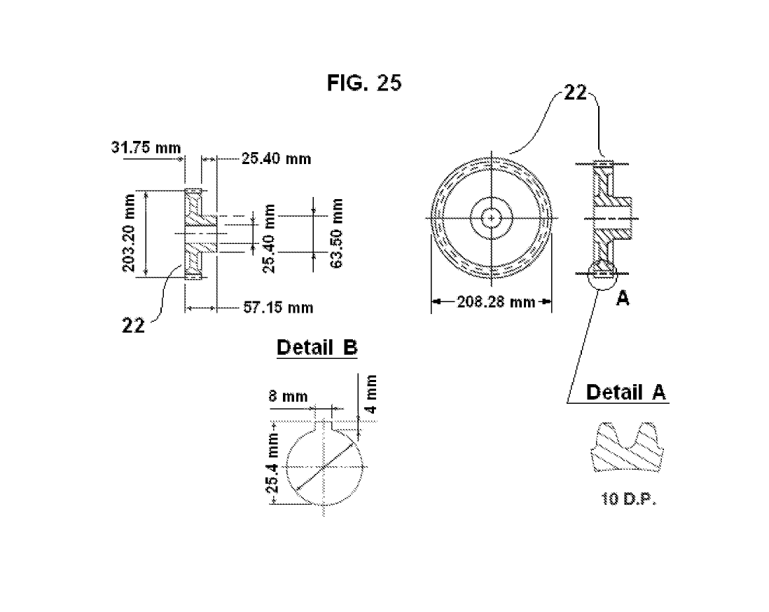

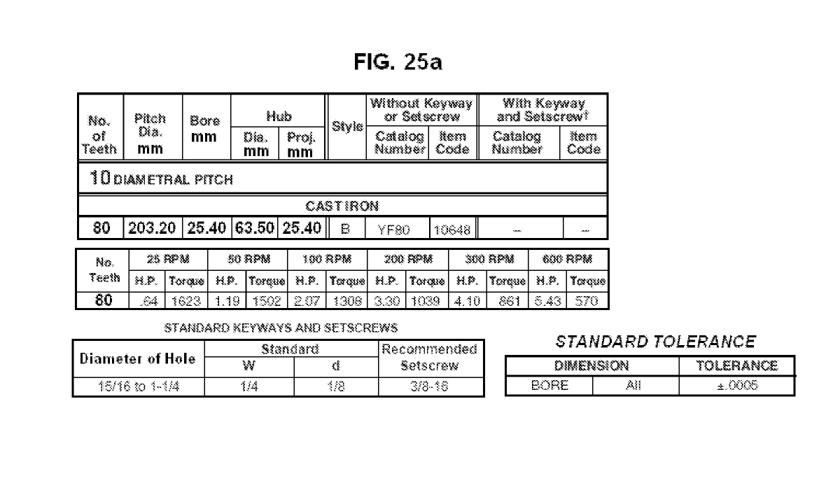

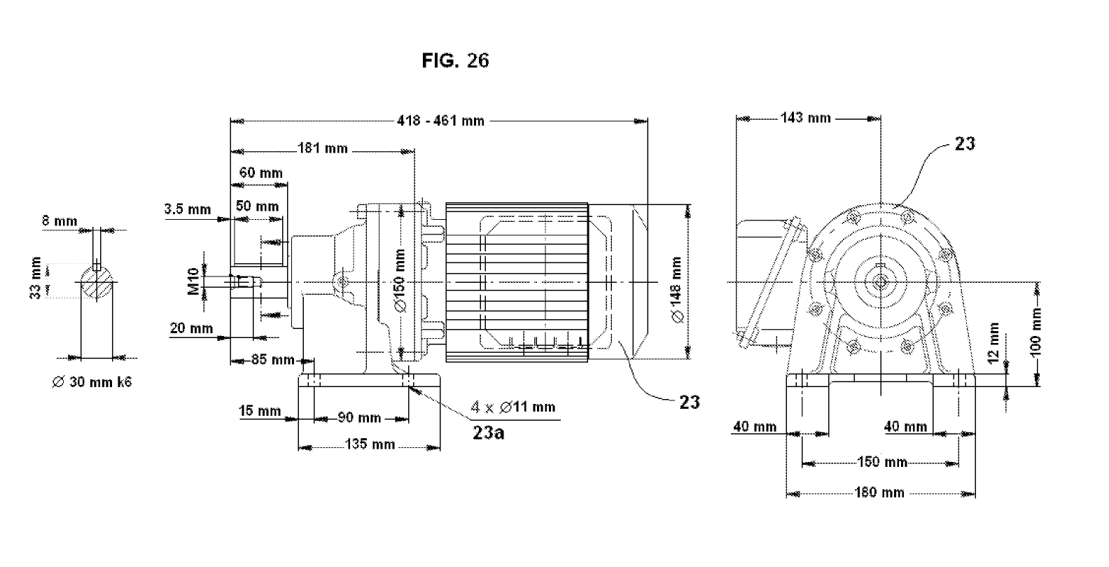

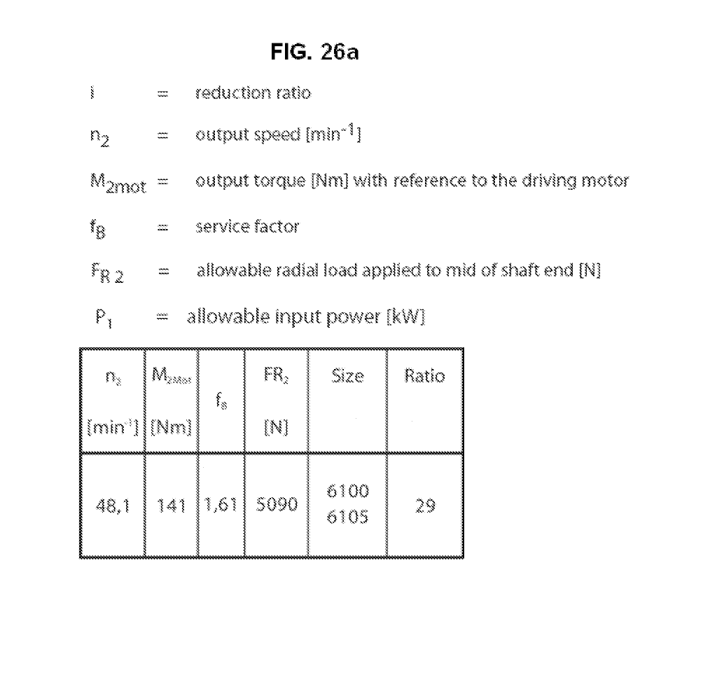

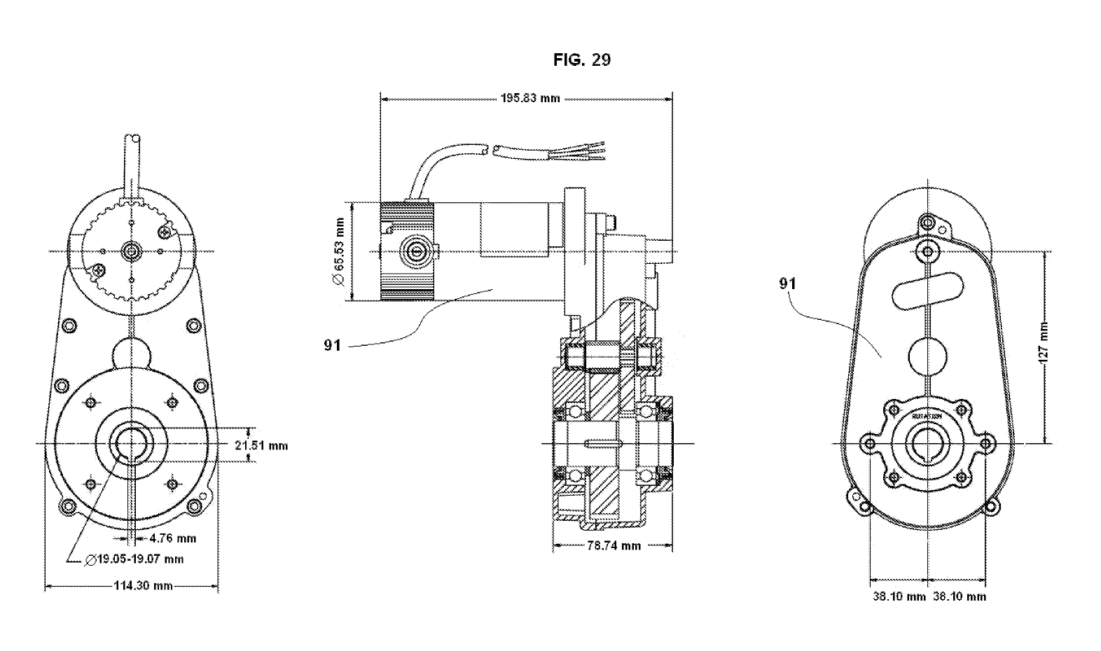

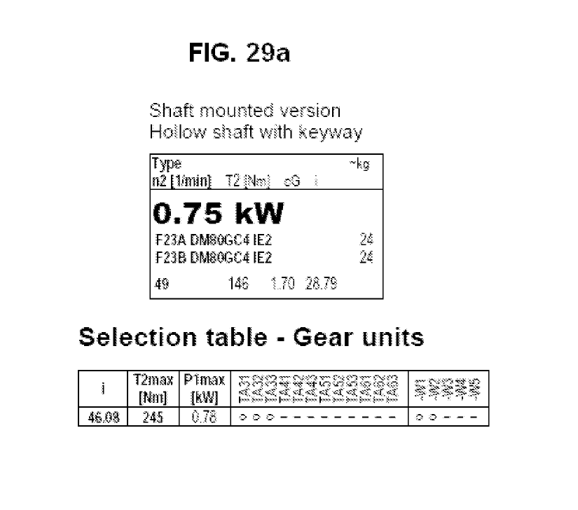

The Recycling Compartment (Crusher/Shredder system) includes the following parts and equipment:
a. Feeding hopper 12 with door and lock 2 (560 mm (W)×560 mm (L)×360 mm (H)) for feeding all kind of waste to crusher/shredder chamber 21 (Actuator Rammer could be attached to hopper if required)
   i. Stainless steel feeding hopper 12 (shown on FIG. 5) with door and lock
   ii. Air filter & exhaust fan 15. Third factor which considered in design is ventilation. Recycling process crushing/shredding will create dusts which need to be exhausted by fan from feeding hopper. Air filter 15d attached to fan absorb the big particles and exhaust the clean air to ventilation duct or outside the machine. Filter will be removable and washable. Filter fixed between front grill 15a and back grill 15b and attached to fan. Opening 15c cut on feeding hopper for installation of fan. Details & fan specification shown on FIG. 6.
   iii. PVC flexible pipe/duct 72 (For connection to main ventilation duct)(Optional if main duct available in location)
   iv. Water Spray Nozzles 9 (2 Nos.) fixed in top of hopper to spray the water for washing of recycled materials and inside the chamber/blades. Nozzles spraying in full cone to cover the whole area of feeding hopper. Nozzle details, dimensions and specification shown on FIG. 7.
   v. Rammer (Actuator rammer which could be optional)
   vi. Solenoid valve 11 is a Electrical valve to supply water to spray nozzles 9 and disposal compartment. Water flow will be controlled by this valve and shall be connected to water tab by water hose 75. Solenoid valve 11 connected to nozzles 9 and sink 8 through plastic pipes 10 and fittings 76. Solenoid valve details, dimensions and connections shown on FIG. 8 & FIG. 8a. Machine water supply diagram shown on FIG. 9.
   vii. Liquid dosing pump/Micro diaphragm liquid pump 56 have been considered in machine to dispense/deliver an accurate amount of liquid (Liquid Dishwasher, Liquid Pipe Cleaner or any other liquid detergents based on the materials and application) through suction/delivery tubing 60/61 and injection connectors 63 to water supply pipes 10 for washing of recycled materials or removing of dirt/odor from recycling or disposal compartment, drain pipes and Solid/Grease Trap. Detergents will be dispensed only to recycling compartment although pipe cleaner and odor removal liquid will be dispensed to both recycling and disposing compartment during recycling/disposal process to avoid any sediment and odor. There is feeding compartment 65 for Liquid Dispenser at top panel with door 65c (Door with hinge 65a and knob 65b) to fill the tanks 57 & 58 when required. Tanks which fixed by mounting bracket/support 59 below feeding compartment 65 will have sensor 62 to show the low level of liquid. Tanks 57 & 58 connected to feeding compartment thread 65d by PVC pipes 66. Liquid dosing pump 56 details and specification shown on FIG. 10 & FIG. 10a. Feeding compartment 65 views and dimension shown on FIG. 11.
b. Main housing/Chamber for crushing/shredding (Drop in Housing) (360 mm (L)×315 mm (W)×160 mm (H) and Cutting Edge (Cutting Assembly) of 300 mm (L)×265 mm (W) including of:
   i. Chassis 35 (To support the Main (crusher/shredder) housing. This chassis frame 35 built from steel stripes 77 (25 mm width) & 78 (55 mm width) with 5 mm thickness which welded together. Chassis views and dimension shown on FIG. 12. Chassis frame 35 will be welded to steel angles 36 and then to compactor chassis 38. FIG. 13 shows chassis frame dimensions and connection detail of both chassis and angles.
   ii. Housing/chamber 21 made from Ductile Iron and will be assembled with bolts & nuts 84. FIG. 14 shows all crusher/shredder housing/chamber 21 views and details.
   iii. Cutter cartridges & blades. The cutters shall be a large cutter cartridge 86 type including of a 5-tooth cam shaped cutter elements 86a (or 7-tooth 86b or combination of 3-5-7 tooth). FIG. 15 shows the cutter cartridges and blades views, dimensions and details. To have small particle size, the height of the tooth considered ½-inch (13-mm) above the root diameter. Cutter thickness is 7.69 mm and cutter to cutter distance is 8.17 mm. Cutter to cutter root diameter overlap will be 3.8 mm to maintain the best possible cutting efficiency and minimum amount of frictional losses. FIG. 16 shows 5-tooth cam shaped cutter 86a option details. The cutters shall apply a minimum force of 450-lbs./HP (2680-N/kW) continuously and 1430-lbs./HP (8530-N/kW) at momentary load peaks at the tooth tip. Selected gearmotor 23 create such a force for proper operation of cutter cartridge. Cutter outside diameter is 126 mm. The fixed cleaning blades 81 considered in design and will increase the cutting/crushing process efficiency. FIG. 17 and FIG. 18 show perspective and details/dimensions of the cleaning blades.
   iv. Twin 2.32″ hexagonal shafting (59 mm). Crusher/shredder drive shaft 82 and driven shaft 83 shall be made of heat treated hexagon steel with a tensile strength rating of 135,000-psi (930.8-MPa). Shafts sizes considered of 2.32 inch hexagon 59 mm. Drive hex. shaft 82 front portion have two steps which first step 82a (51 mm Dia.) considered for thru bearing-mechanical seal 90/drive gear 79 and second step 82b (25 mm Dia.) for fixing of spur gear 22. Bearing & gear will fix by shaft keys 88 & 87 to shaft. Back portion of drive shaft have one step 82c (25 mm Dia.) for fixing of end bearing-lock-mechanical seal/cap 90/90a. FIG. 19 shows drive shaft views, dimensions and perspective. Driven hex. shaft 83 also designed with two steps which front step 83a (51 mm Dia.) considered for thru bearing-mechanical seal 90/driven gear 80 and back step 83b designed for end bearing-lock-mechanical seal/cap 90/90a. FIG. 20 show driven shaft views, dimensions and perspective.
   v. Bearing/seal housing sets 90 (End & thru). The cutter shaft's radial and axial loads shall be borne by a sealed deep-groove ball bearing 90 at each end. The bearings shall have basic dynamic rating of 9230 lbs. The bearings shall be protected by end face mechanical seals. The bearings and seals shall be a replaceable cartridge that supports and aligns the bearings and seals. The tolerances for the total width including bearing inner ring stand-out are:—±0.5 mm for units incorporating bearings with bore diameters 50 mm. Bearing/seal housing will fix with bolt 90b & nut 90c to crusher/shredder chamber 21 and end bearing/seal will be covered by cap/end cover 90a. FIG. 24 show bearing/seal views, section, details and specification.
   vi. Gears attached to Hex shafts: Drive gear 79 and driven gear 80 inside Crusher/Shredder Chamber 21 designed to transfer the movement/torque from drive shaft 82 to driven shaft 83. Keyways 79a & 80a have considered in gears for connection of gears to shafts. FIG. 21 & FIG. 22 show the drive and driven gear views, dimensions and perspectives. FIG. 23 shows the basic fundamentals used in gears design.
   vii. Spur gear wheels 22 between Cutter Shaft & Motor shaft; Both gears will be 10 Diametral Pitch Spur Gears from Cast Iron (20° Pressure angle) and will transfer the torque, power and movement from motor/reducer shaft to crusher/shredder drive shaft 82. Spur gear views, section and details shown on FIG. 25. Spur gear typical specification shown on FIG. 25a.
   Viii. Motor/Reducer 23: The gearmotor & speed reducer 23 considered CYCLO Drive. CYCLO components operate in compression, not in shear. The speed reducer is cycloidal type reducer with “Heavy-Shock” load classification. The reduction ratio considered 29:1. The gearmotor selected based on reduction ratio (i) of 29:1, output speed (n₂) of 48.1 min⁻¹, output torque (M₂ₘₒₜ) of 141 Nm, service factor (f_{B}) of 1.61, allowable radial load (F_{R2}) (applied to mid of shaft end) of 5090 N and allowable input power (P₁) of 0.75 kW. The gearmotor is universal mounting—1 stage foot mount (4 holes 23a 11 mm dia. for bolts & nuts). Gearmotor views, dimensions shown in FIG. 26. The gearmotor specification, selection factors and model shown on FIG. 26a. The second option for Motor/Reducer is shaft mounted helical gear unit (Type F) 91. This motor unit has less weight and occupies less space and no need of spur gear for transmission of power to crusher/shredder shaft. In case of using helical gear unit, drive shaft diameter should be 19 mm (0.75″) instead 25 mm (1″). FIG. 29 shows the motor views, section and dimensions. FIG. 29a shows motor specification and selection gear table and data.
   ix. Electronic control unit/Control & display panel 68: The electrical unit will control the motor/reducer as per selected material and program through front control buttons 68b & timer 68c and synchronize the crusher compartment with compactor and recycled collection compartments.
   x. Connection (Middle) chamber 64: To connect crusher/shredder 21 and compaction 27 chambers together and have space between two chambers for processing of materials. Connection chamber made from ductile iron and assembled by bolts/nuts 84 (10 mm dia.) and have 5 holes 85 (9 mm dia.) in each side (bottom & top) for connection to crusher/shredder and compaction chambers.

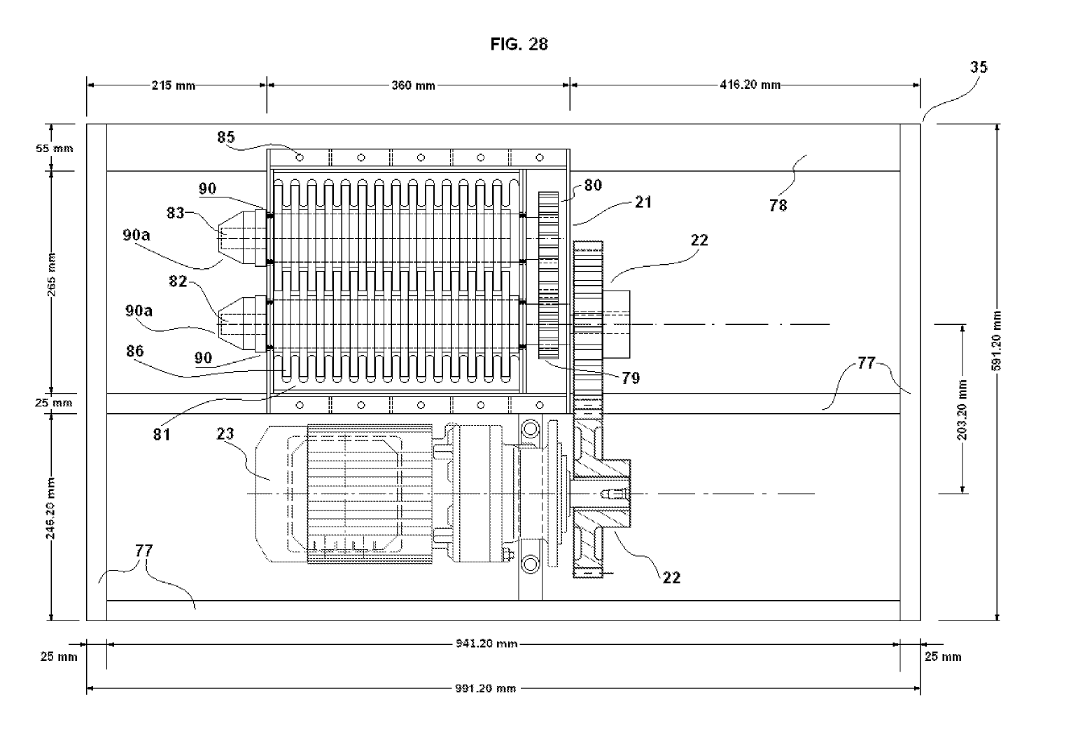

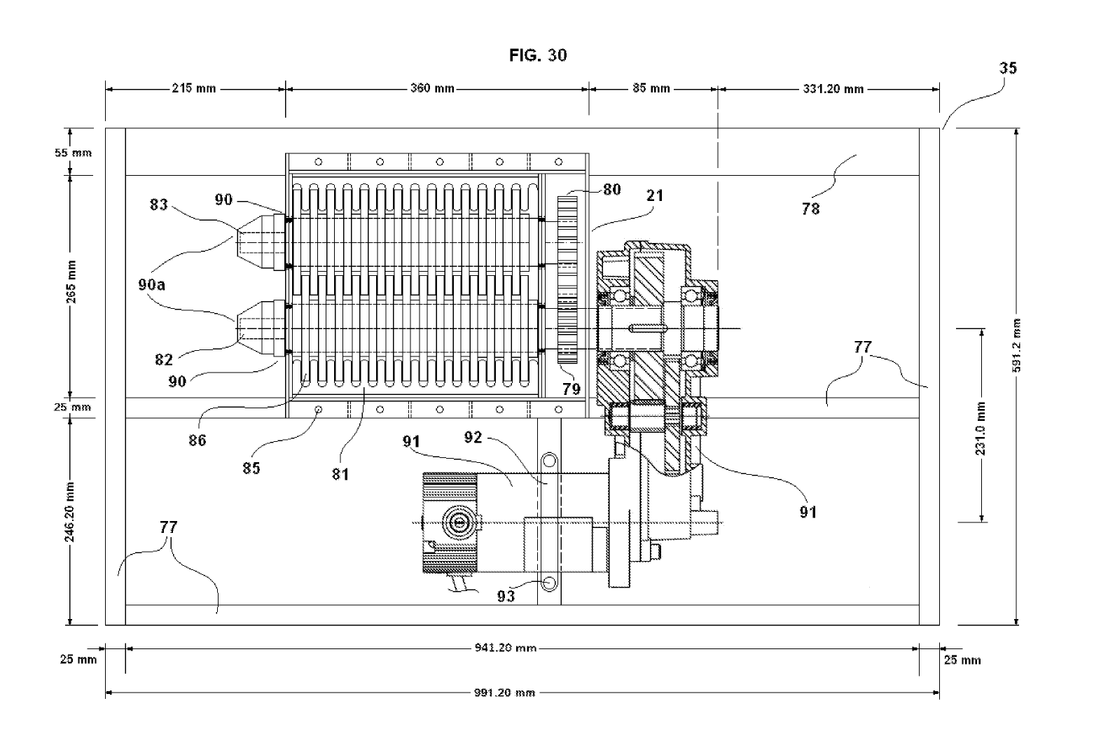

Crushing/shredding compartment full assembly on chassis with motor and spur gears shown on FIG. 28 (Top view). As a second option FIG. 30, shows full assembly of crushing/shredding compartment, shaft mounted helical motor/gear unit on chassis (Top view) by clamp 92 and bolts and nuts 93.
c. Auger Compactor Unit

Proposed auger pre-crush and compact in one motion. While processing material, the auger 94 continuously runs in a forward direction, crushing and reducing the size of what it is fed and discharge through discharge hatch 98 at front portion of compaction chamber. At the same time rinsing recycled items and dewatering through electric pump 34 (Drain pump). The compactor chamber bottom/sides portion is perforated baffle plate 95 with hole dia. 2.00 mm to drain the water through a drain outlet 31 (elbow 90°) and drain pump 34. Drained water goes to Solid trap/grease trap 37 and finally drains to wall drainage pipe. Drain pipe 32 is 1.5″ dia. (38.1 mm). Recycled items could be compacted up to 5 times (Some materials up to 8 times) and then evacuate/feed to receiver container 25 and then discharge to plastic bins 40 by actuator 19 which attached to a compaction disk 24. Compactor chamber 27 and receiver container 25 are attached together and shocks and movements during discharging from compactor to receiver container will absorb by gas traction springs 26. When receiver container becomes full, sensor 106 will stop auger 94 movements and actuator 19 will compact and discharge the recycled clean materials to plastic bins 40. Sensor 106 also stop auger 94 when extraction more than defined limit. Discharge hatch/door 43 at bottom of receiver container 25 will open with delay and after actuator 19 reach to ⅓ of distance travel. For receiver container, an alternative design (Alternative Design II) considered which receiver container 25a is rectangular shape with more capacity compare to round shape container 25.

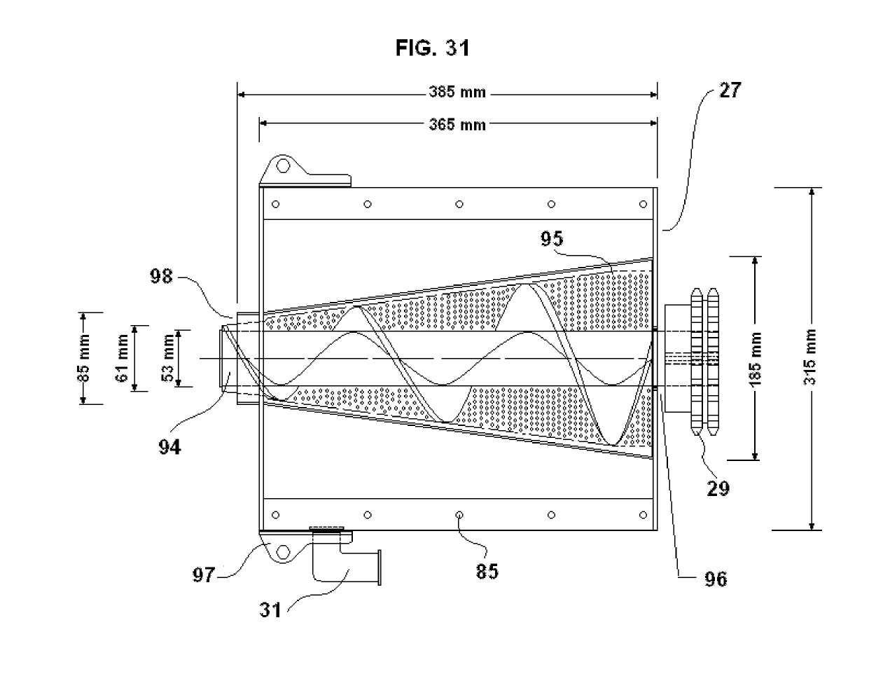

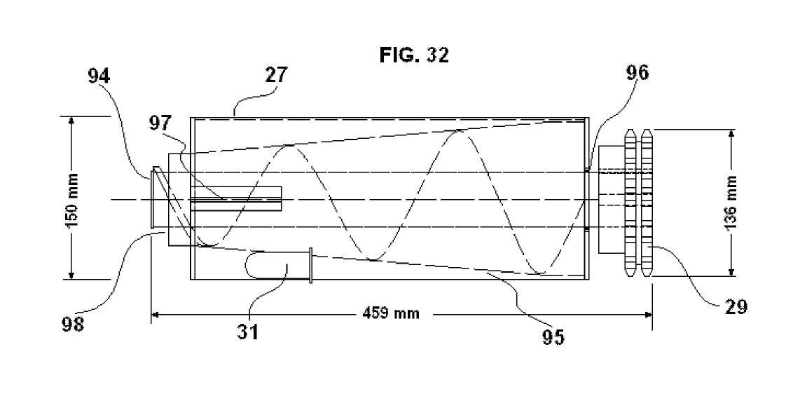

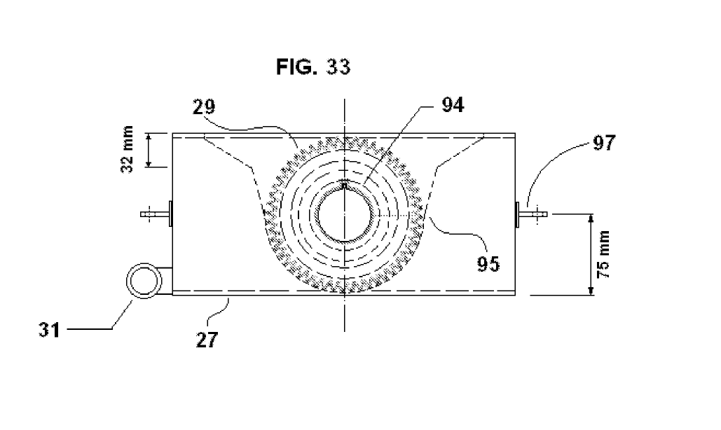

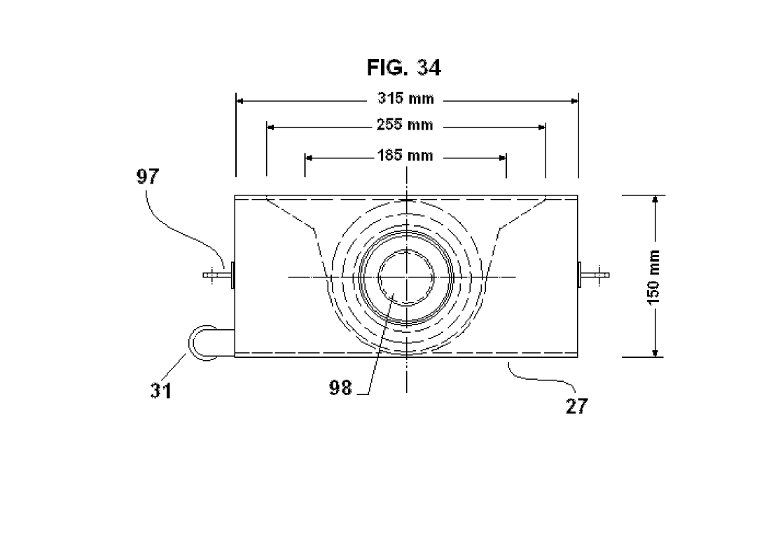

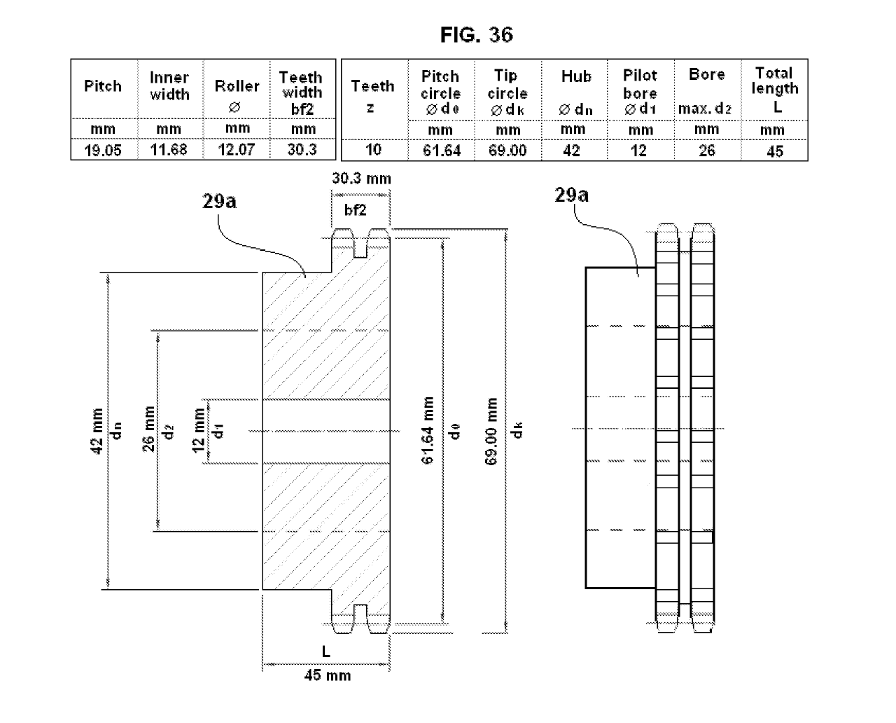

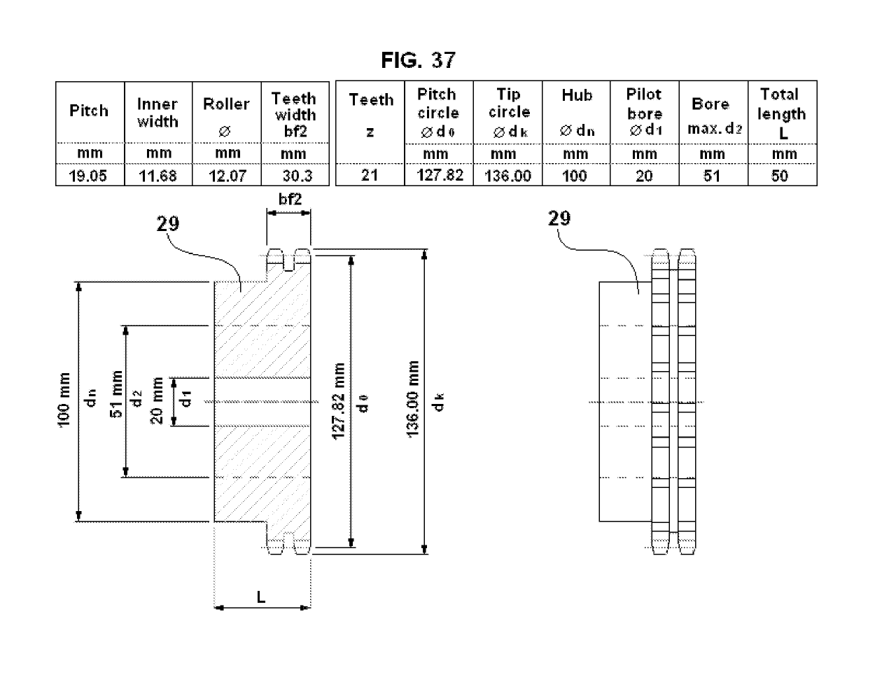

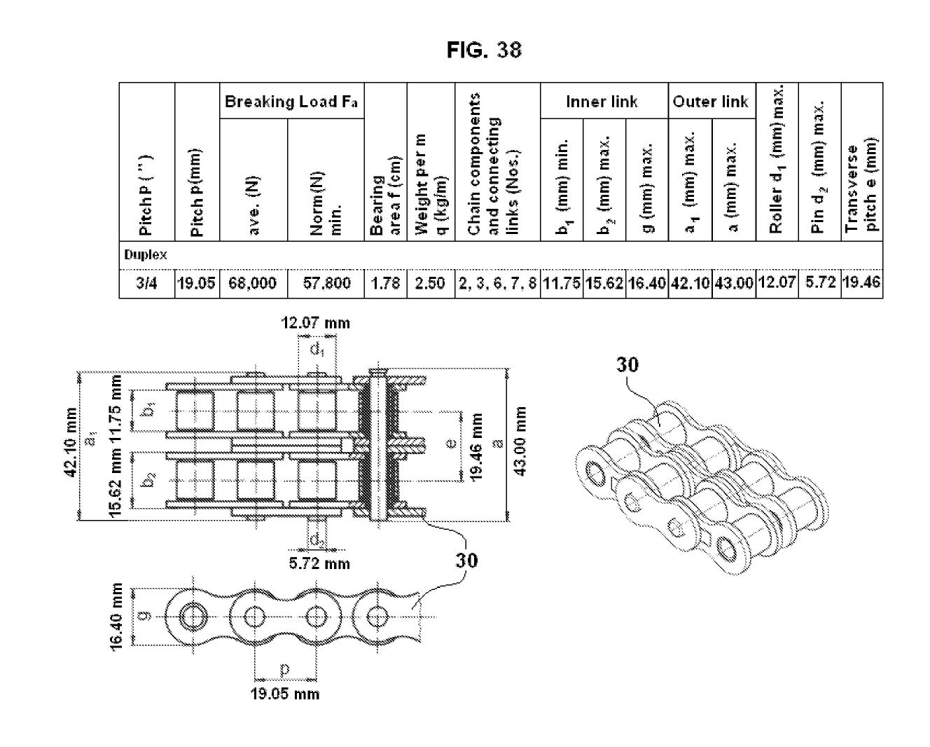

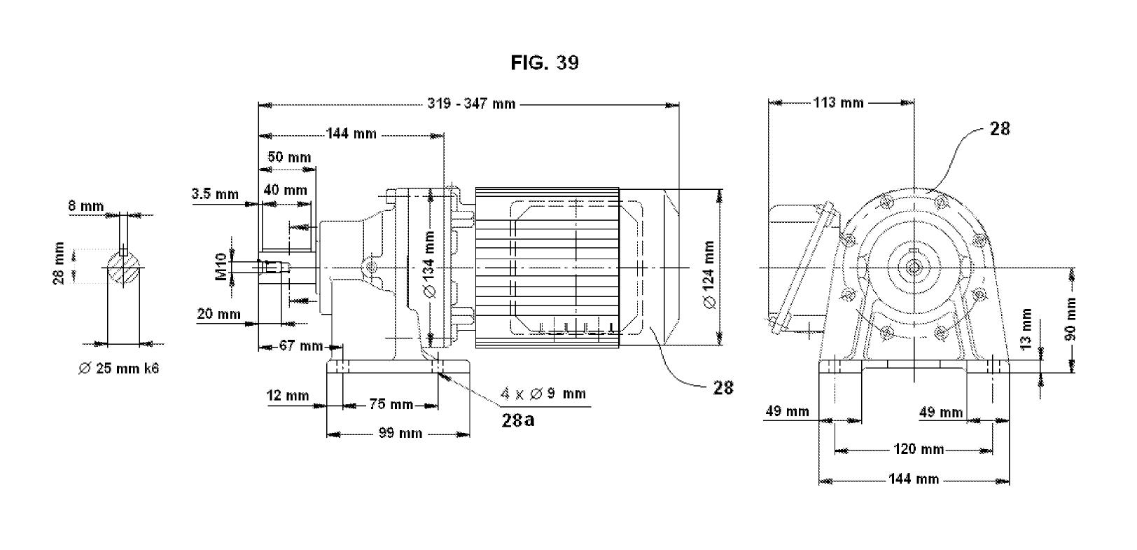

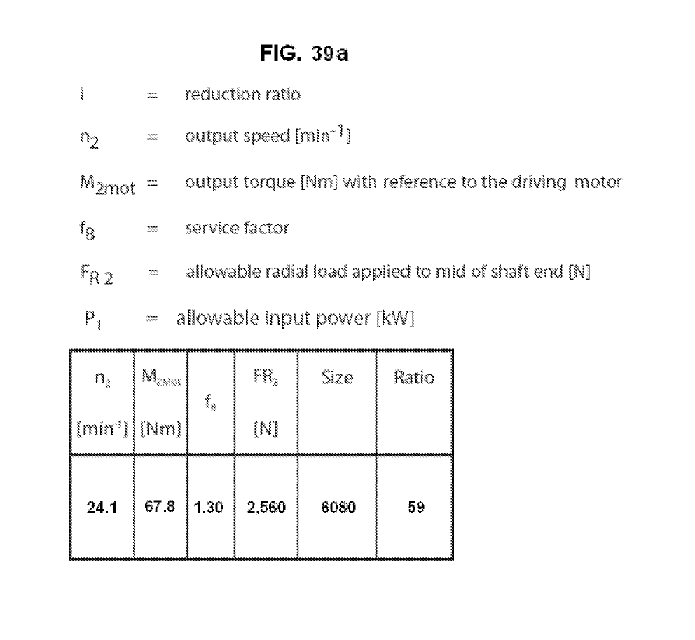

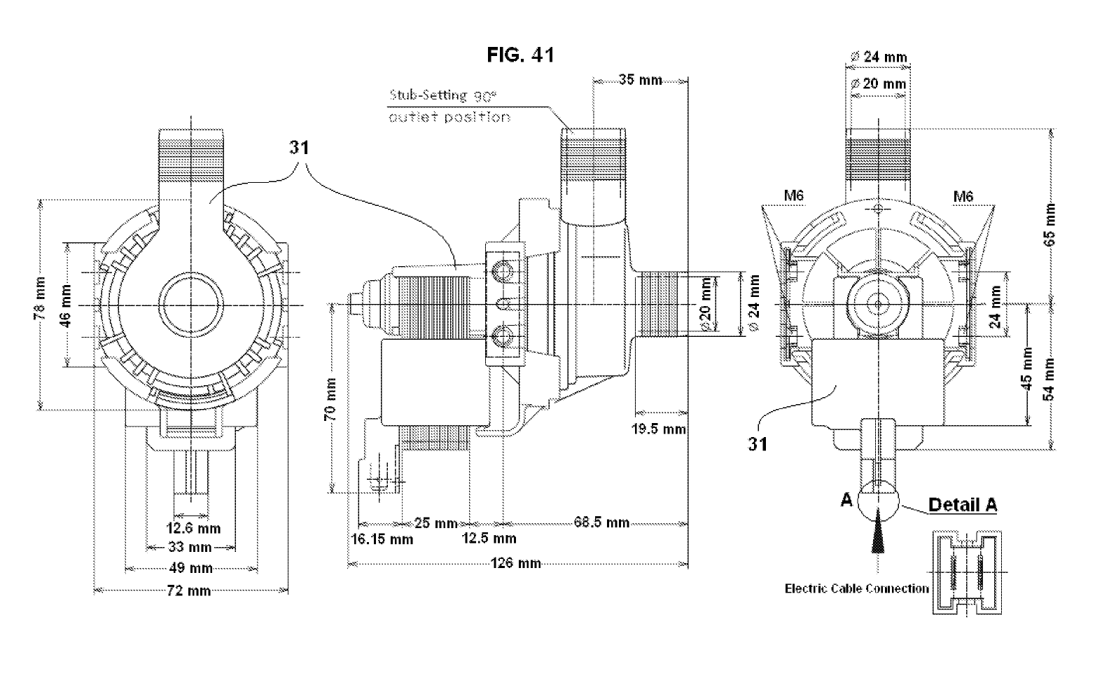

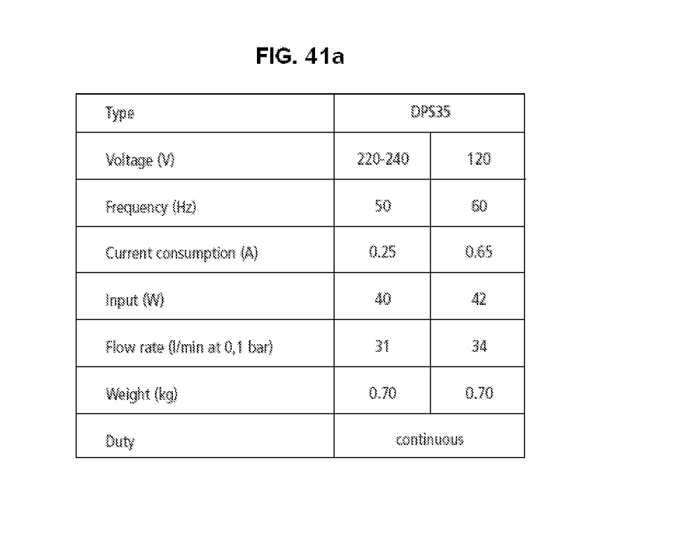

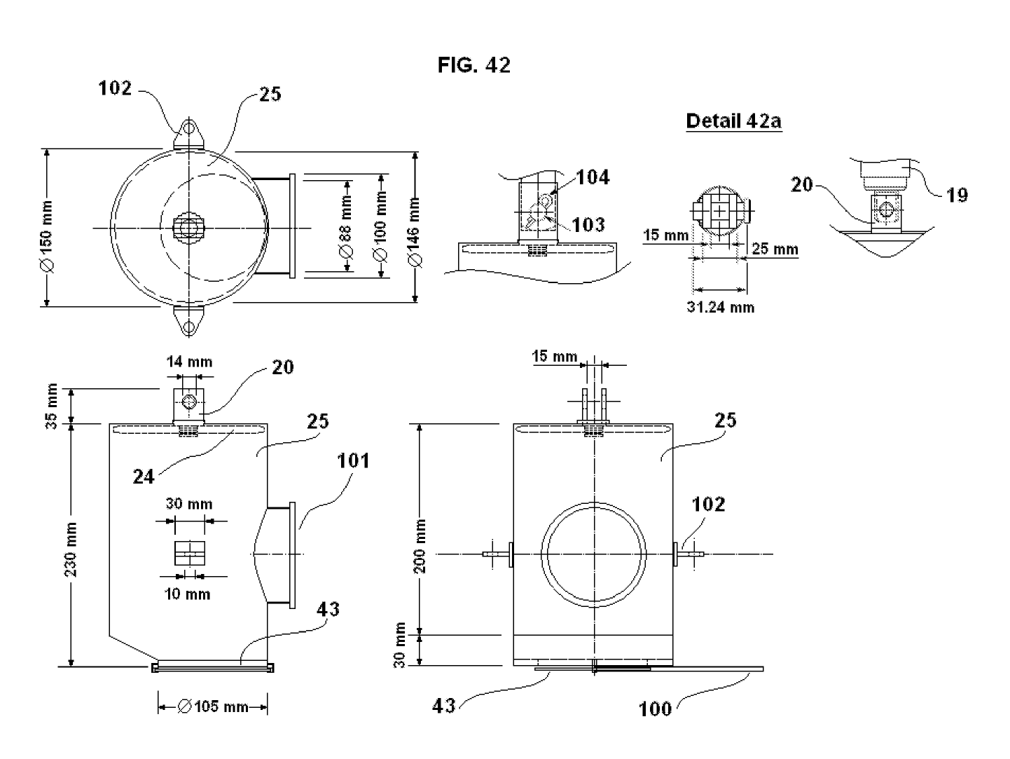

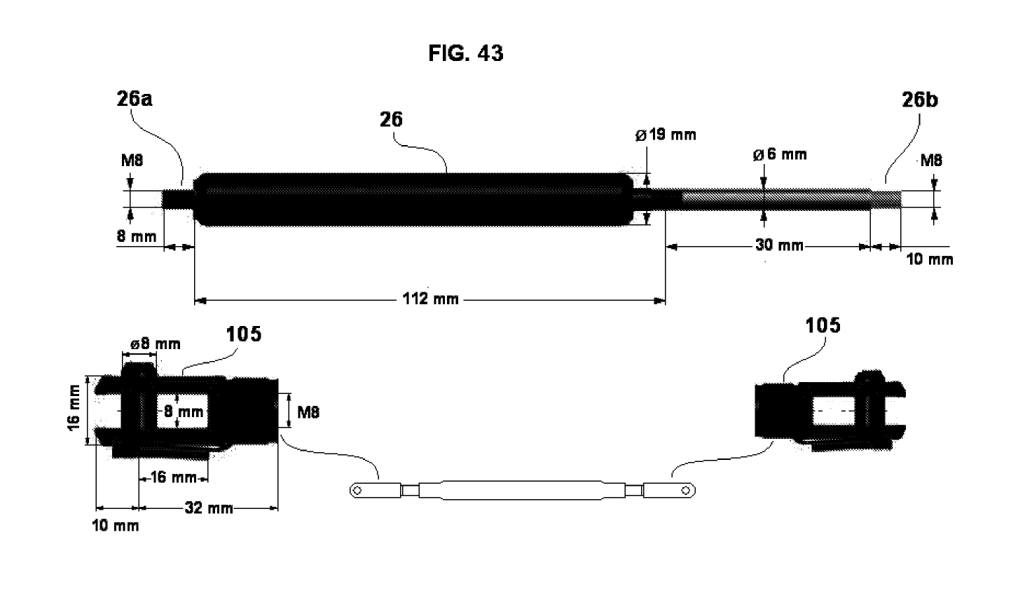

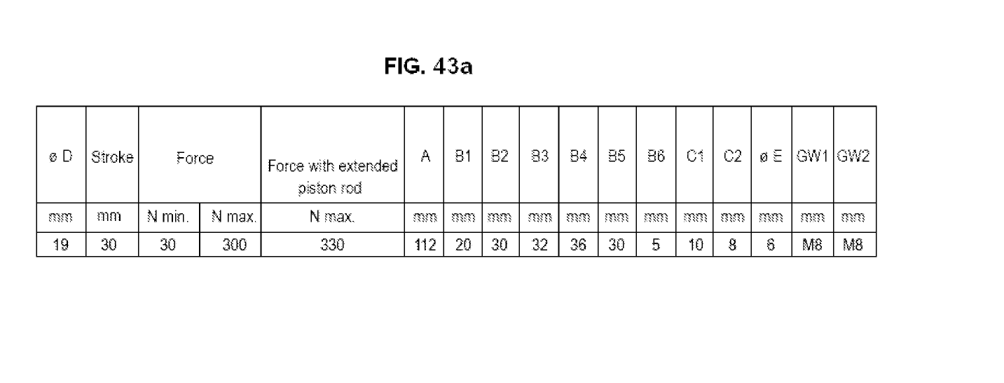

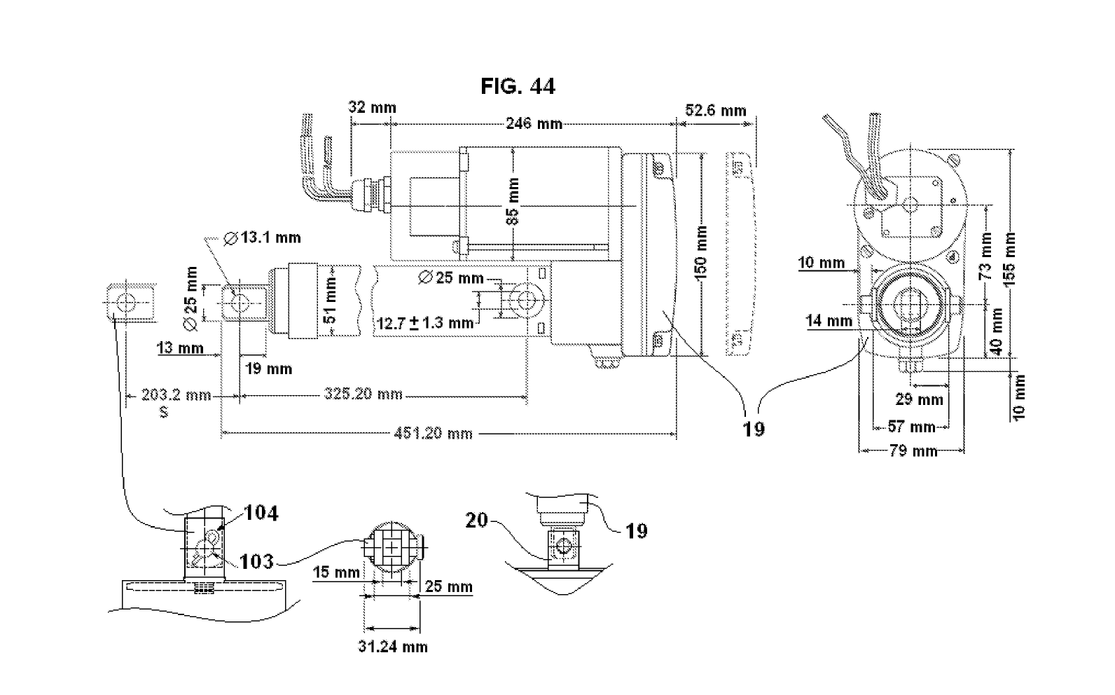

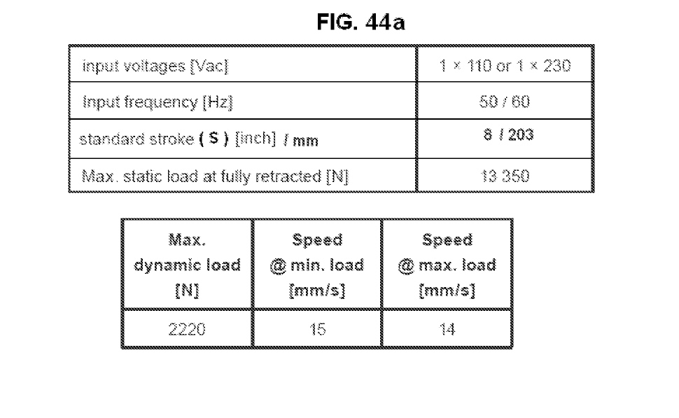

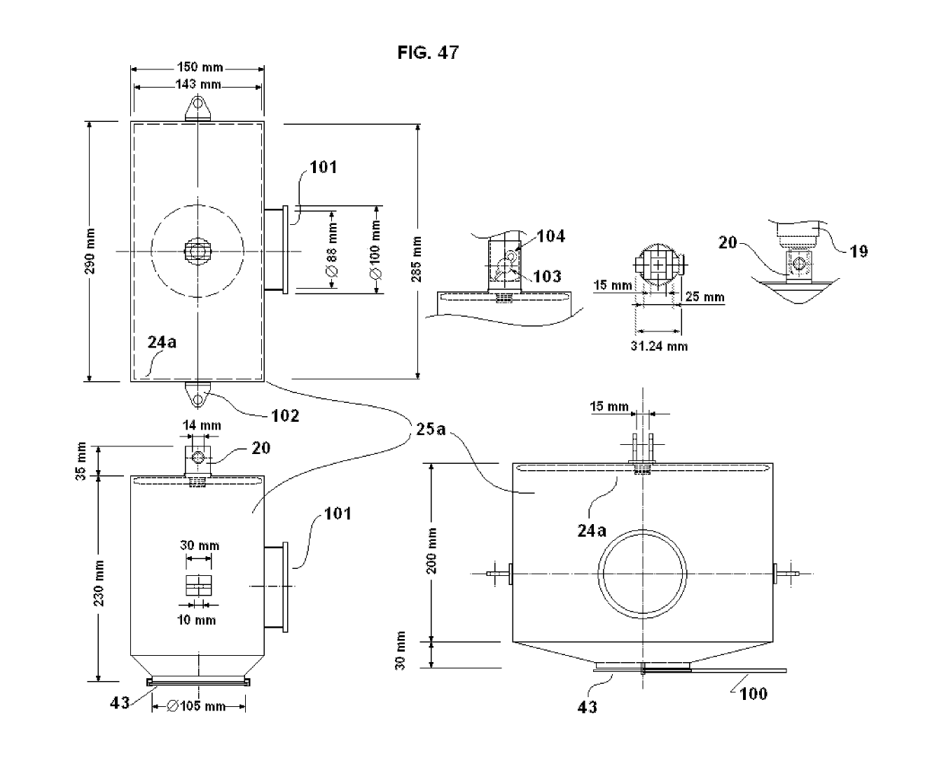

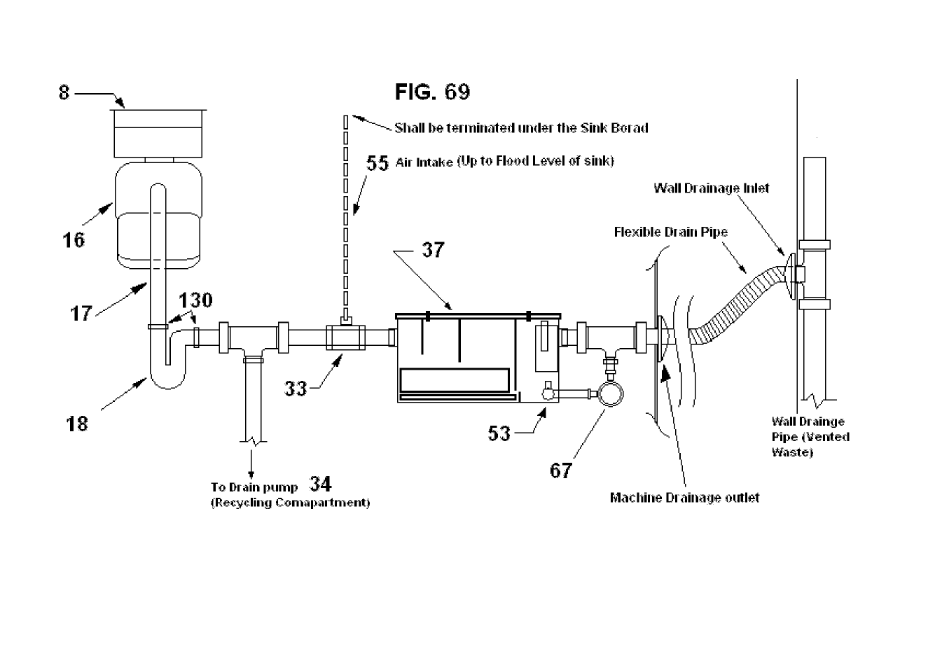

Auger compactor unit including of:
i. Chassis 38: To support the auger compactor chamber, motor and receiver container. This chassis frame 38 built from steel stripes 77 (25 mm width) & 78 (55 mm width) with 5 mm thickness which welded together. Chassis views and dimension shown on FIG. 40 and details 40a. Chassis frame 38 will be welded to steel angles 36 at top and 39 at bottom and then to recycling storage chassis 51.
ii. Housing/chamber 27 (400 mm (L)×315 mm (W)×150 mm (H)) made from ductile iron or steel plate and will be assembled by welding. Compactor chamber 27 have 5 holes 85 (9 mm dia.) in each side (bottom & top) for assembly to connection (middle) chamber 64 and chassis frame 38. FIG. 31 shows compactor chamber top view and dimensions. FIG. 32 shows side view and dimensions. FIG. 33 & FIG. 34 show front and back views of the chamber.
iii. Compacting & cutting/crushing alloy steel auger 94. Auger 94 fixed on 51 mm dia. strong shaft and connected to a sprocket double gear 29a with a key shaft 99. Auger view and dimensions shown on FIG. 35.
iv. Dewatering baffle chamber 95 (Stainless Steel or steel painted plate). Bottom of compactor chamber 27 is a cone shape dewatering baffle chamber 95 with many holes (2 mm dia.) and built from stainless steel or normal steel plate for draining of water from chamber through a drain outlet 31 (Elbow shape outlet connected to side of chamber) and pipe 32 (plastic/rubber drain pipe) by a drain pump 34. All Items after crushing/shredding process will be feed automatically to compactor chamber and will be washed (if required based on material and program selected by user) by water spray nozzles and water will be drained simultaneously during compaction and dewatering by auger. Therefore clean, rinsed and compacted material will be feed to receiver container 25. Details of baffle chamber showed on FIG. 31 to FIG. 34.
v. Bearing/mechanical seal housing sets 96 (End & thru). The auger shaft's radial and axial loads shall be borne by a sealed deep-groove ball bearing 96 at each end. The bearing/mechanical seal avoid of any water leakage to outside of compactor chamber.
vi. Drive Gear & Driven Gear 29a & 29. Duplex sprocket gears installed on auger's shaft 94 and motor/reducer's shaft to transfer torque, power and motion from motor/reducer 28 to auger by a duplex chain 30. Drive & driven gears 29a & 29 views, dimensions and specification showed on FIG. 36 and FIG. 37.
vii. Duplex chain to transfer the motion to auger's shaft 30. Strong duplex chain 30 have been considered on design for efficient transferring of power, torque and motion. Design details, views, perspective and specification of duplex chain shown on FIG. 38.
viii. Motor & speed Reducer 28. The gear motor & speed reducer 28 considered CYCLO Drive for compactor chamber as well. The gearmotor selected based on reduction ratio (i) of 59:1, output speed (n₂) of 24.1 min⁻¹, output torque (M₂ₘₒₜ) of 67.8 Nm, service factor (f_{B}) of 1.30, allowable radial load (F_{R2}) (applied to mid of shaft end) of 2560 N and allowable input power (P₁) of 0.18 kW. The gearmotor is universal mounting—1 stage foot mount (4 holes 28a 9 mm dia. for bolts & nuts). Gearmotor views, dimensions shown in FIG. 39. The gearmotor specification, selection factors and model shown on FIG. 39a.
   ix. Electronic control unit 68: The electrical unit will control the compactor's motor/reducer and synchronize the crusher with compactor & actuator as per selected material and program through front control buttons 68b & timer 68c.
   x. Dewatering electric pump (Drain pump) 34 to drain the water from compactor chamber after rinsing & during compaction. FIG. 41 shows drain pump 34 views and dimensions. FIG. 41a shows drain pump 34 specification.
   xi. Drain Hose/Pipe 32 (Rubber hose or flexible plastic pipe) from drain pump 34 to Solid Trap 37. This rubber hose 32 will connect the drain outlet 31 to drain pump inlet and from drain pump outlet to flow control 33 and then to solid trap/grease interceptor 37. Detail of drainage connection shown on FIG. 69.
   xii. Recycled materials receiver container (Round shape 25 & rectangular alternative design 25a for more capacity) to receive the compacted, washed and rinsed recycled materials. Receiver container 25 feeding hatch 101 will be connected to discharge hatch/gate 98 of compactor chamber 27. Compaction disk (Round shape 24 & rectangular shape 24a) move vertically inside the receiver container 25/25a to double compact and discharge the materials to storage plastic bins 40. FIG. 42 shows round shape receiver container 24 details, views and dimensions. FIG. 47 shows rectangular shape receiver container 24a details, views and dimensions.
   xiii. Receiver container discharge door/hatch 43: Will be open with some delay after actuator starts the 2^{nd} compaction stage and discharging the recycled materials. This discharge hatch/door 43 move horizontally in a guide rail bracket 100 and will be closed automatically after completion of discharge process.
   xiv. Compactor spring/Gas traction spring 26 to absorb all the shocks and movement during feeding from compactor chamber 27 to receiver container 25. Auger 94 will be stopped by sensor 106 if extraction exceed more than defined limit. Design Alternative II for receiver container is a Rectangular Container 25a with more capacity instead of round shape container 25. Gas traction springs 26 will be connected to compacter chamber hook 97 and receiver container hook 102 with FC2 type clevis 105 connections (Clevis with pin). Gas traction 26 and clevis 105 views/dimensions shown of FIG. 43. Gas traction 26 specification shown on FIG. 43a.
   xv. Actuator 19 & Compaction disk 24 (24a Rectangular shape compaction disk): To compact and discharge the recycled items to bins 40). Actuator 19 motor rotation converts to vertical movement and will move down the actuator's extension tube which attached to compaction disk 24 through a mounting pin 20 and re-compact (2^{nd} stage of compaction) the feed materials and by the time the disk reach to one third of distance travel, discharge hatch 43 will be open and recycled materials will be discharged to bins 40 below the discharge hatch 43. Discharge door 43 will be closed after completion of discharging process. Actuator front adaptor will be connected to clevis mounting bracket 20 (By pin 103 & pin retainer 104) which attached (welded) to compaction disk 24. Actuator views, dimensions and connection details between mounting bracket 20 of receiver container and actuator 19 shown on FIG. 44. Actuator specification shown on FIG. 44a.

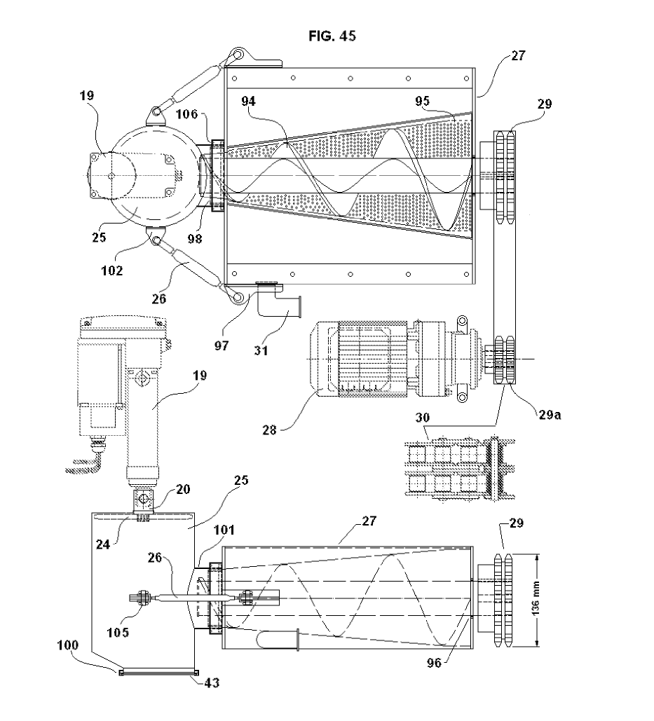

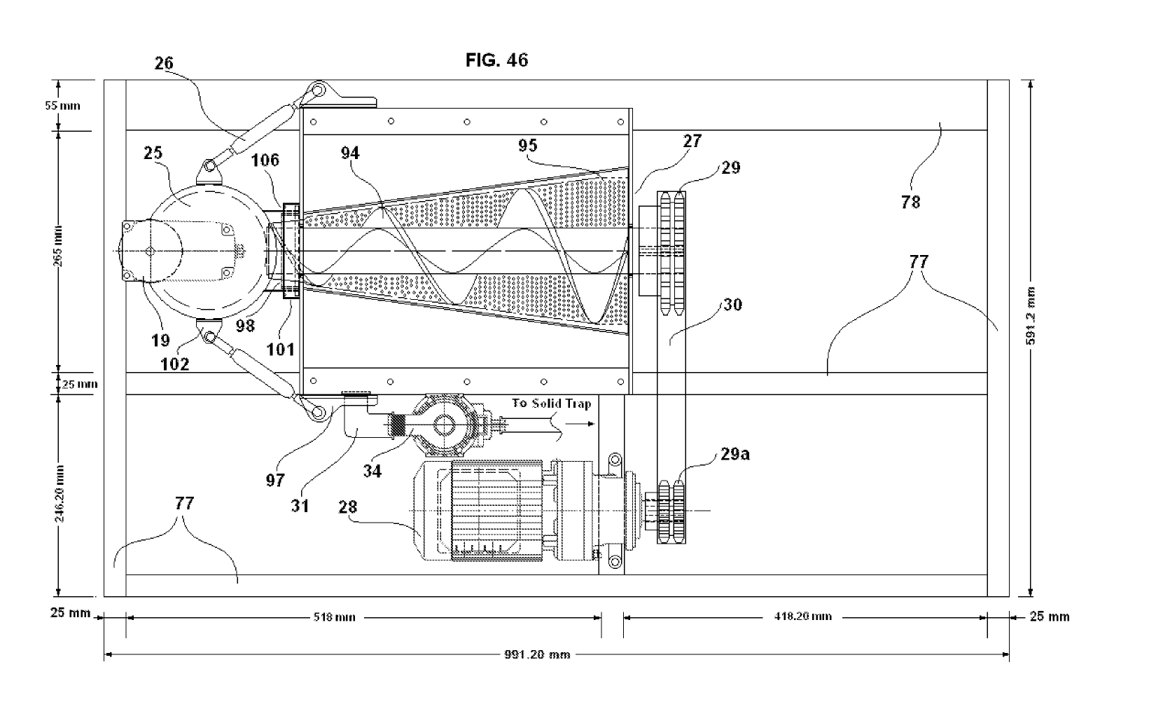

Assembly details (Top & side views) of compactor compartment, receiver container (round shape 25), motor/reducer 28, actuator 19 and gas traction spring 26 shown on FIG. 45. Full assembly details with dimensions of compaction compartment, receiver container 25, drain pump 34, actuator 19, gas traction spring 26 and motor/reducer on chassis shown on FIG. 46.

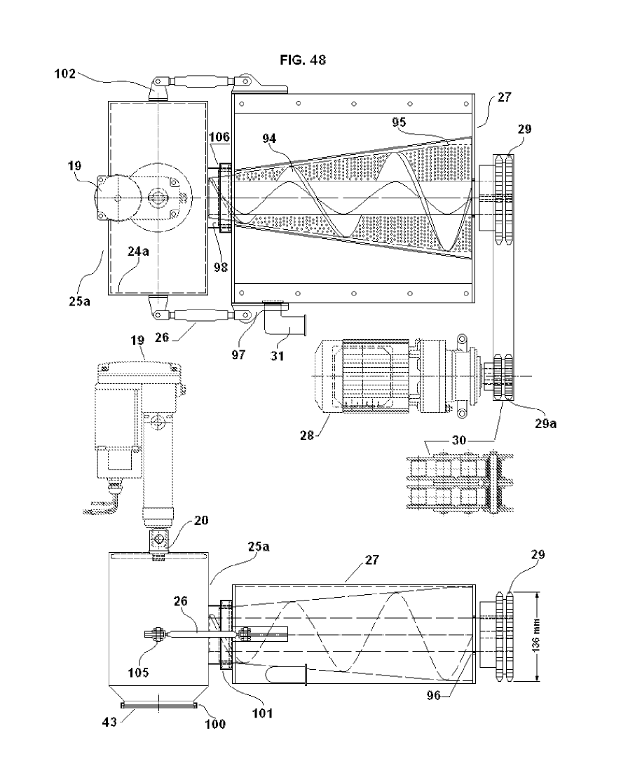

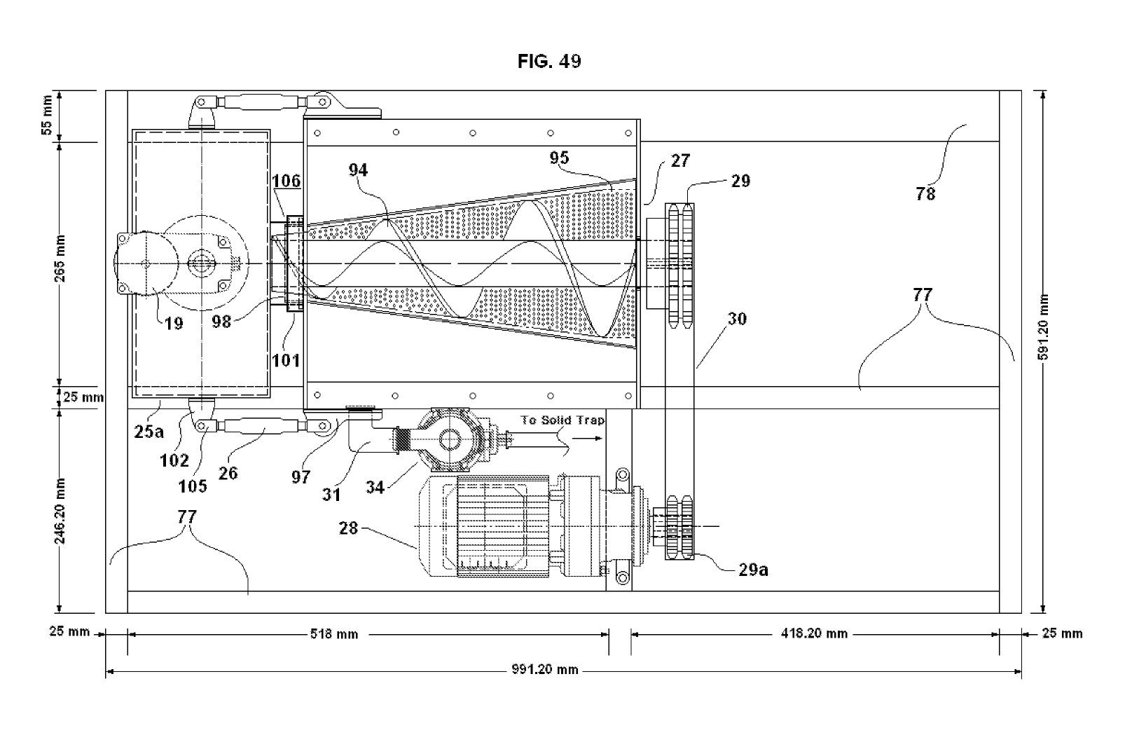

Assembly details (Top & side views) of compactor compartment, receiver container (rectangular shape 25a), motor/reducer 28, actuator 19 and gas traction spring 26 shown on FIG. 48. Full assembly details with dimensions of compaction compartment, receiver container 25a, drain pump 34, actuator 19, gas traction spring 26 and motor/reducer on chassis shown on FIG. 49.

B—Recycled Collection Compartment (Rotary Collection Bins System for Recycled Items)

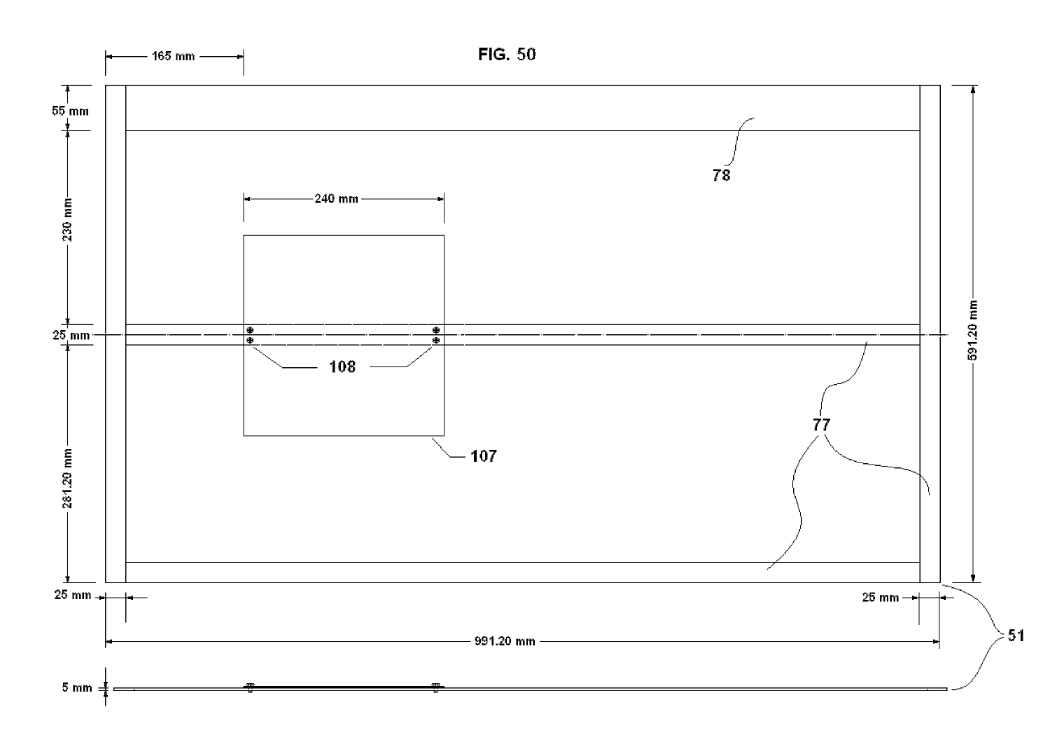

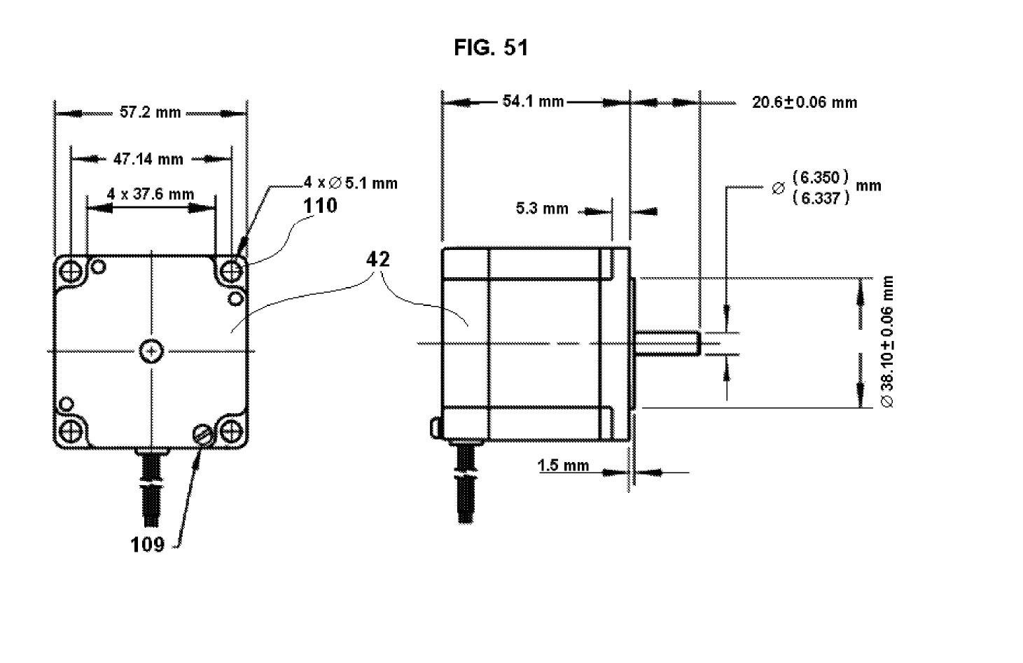

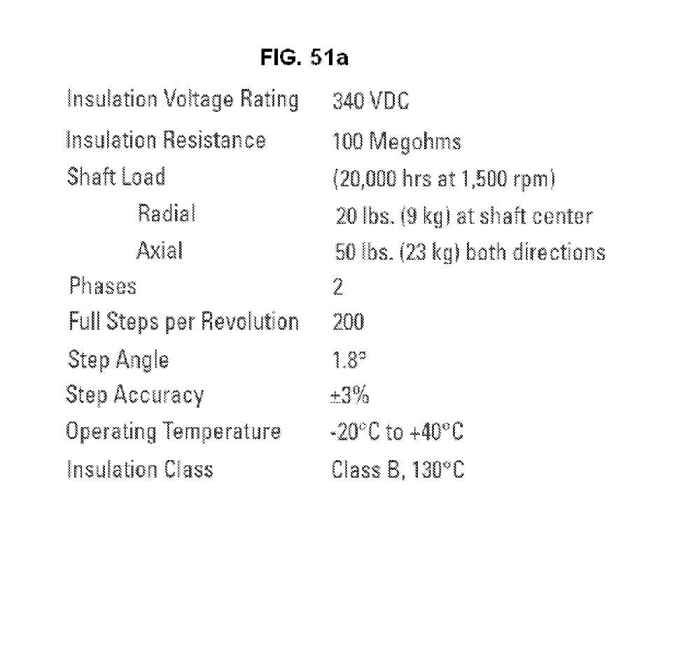

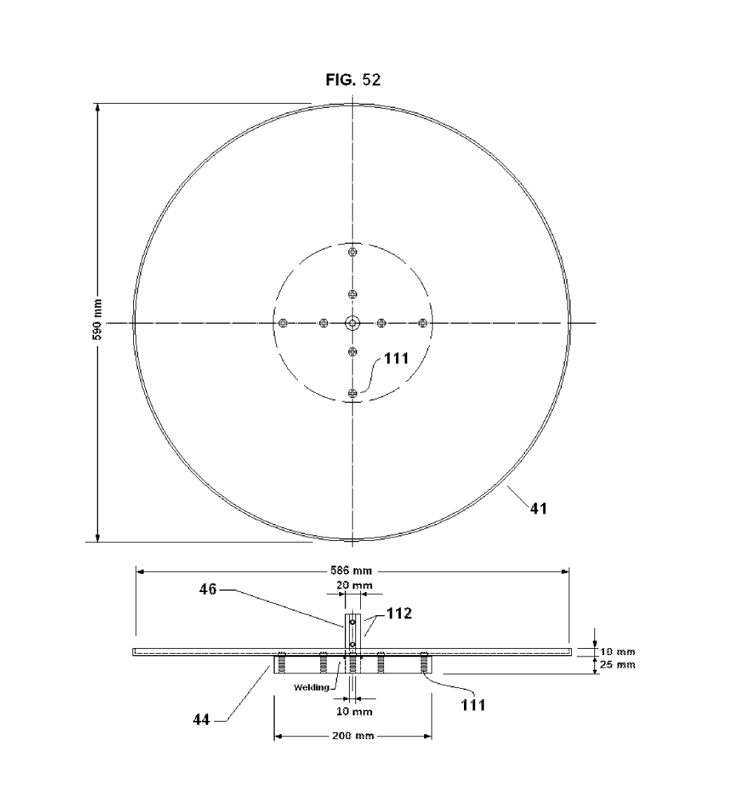

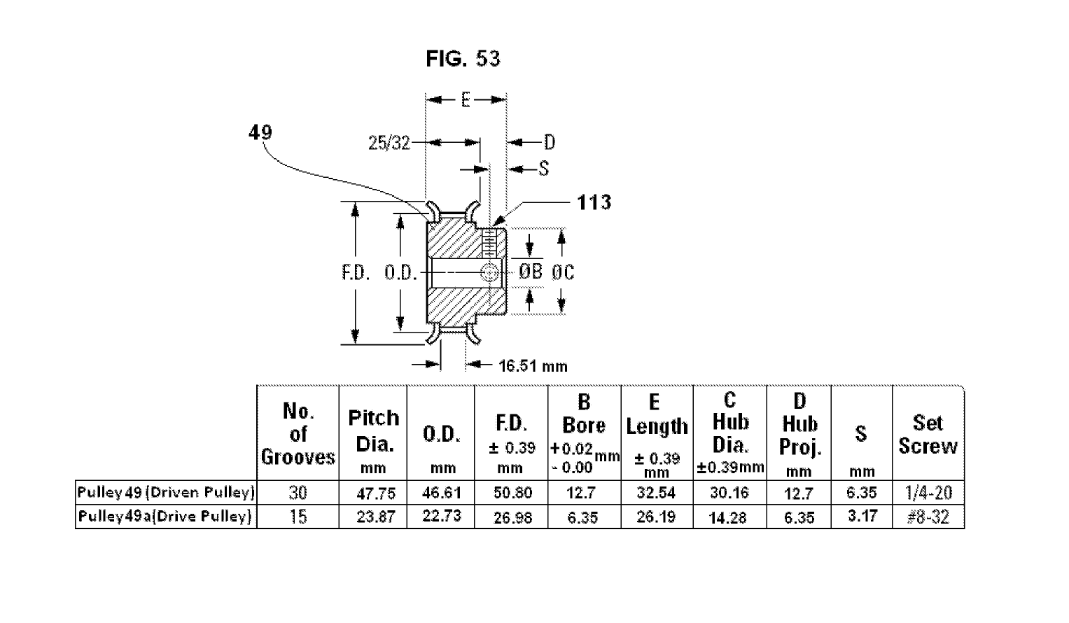

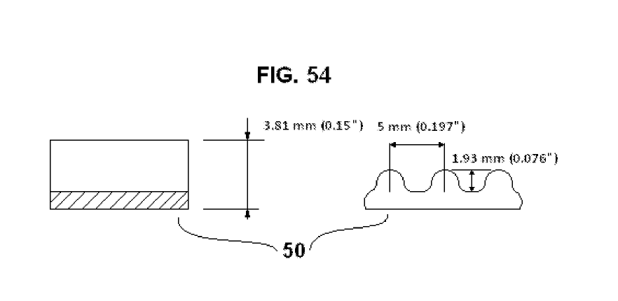

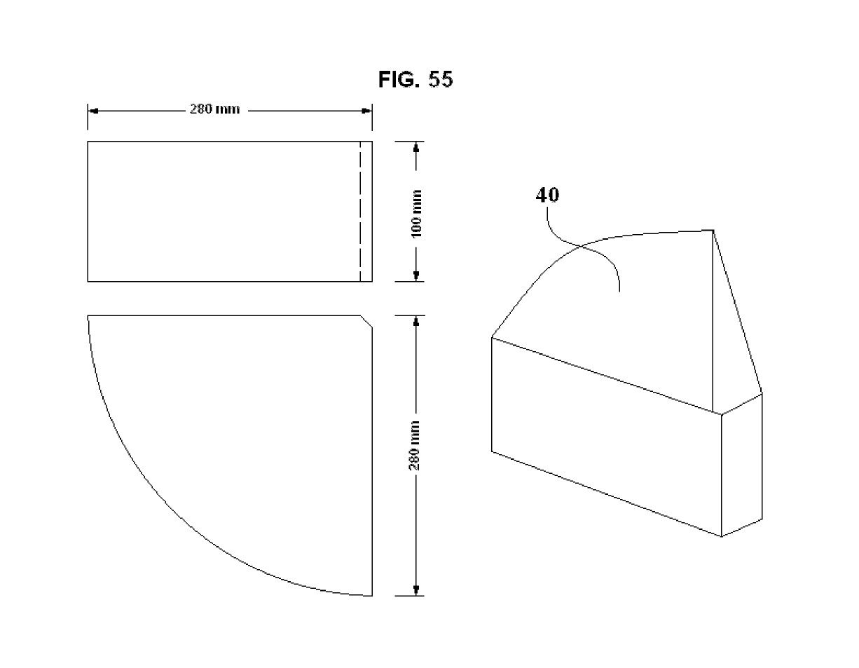

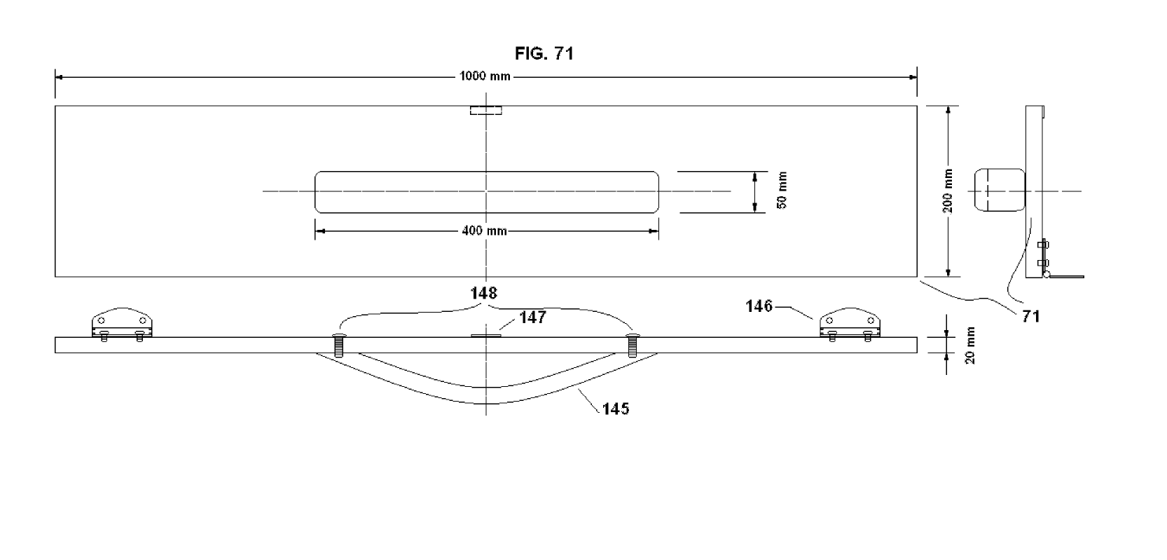

This compartment will sort and store different recycled materials which compacted to maximum level, washed, rinsed and dewatered after discharging from compactor's receiver container. Based on initial selection and program by user each items will be sort and stored in a designated plastic bin 40. Recycled collection compartment includes of following section/part:
I. Chassis 51 (Bottom support frame): This part of chassis will be connected to middle (compactor) chassis 38 and will support the recycled storage/collection compartment. This chassis frame 51 built from steel stripes 77 (25 mm width) & 78 (55 mm width) with 5 mm thickness which welded together. A base plate 107 connected by screws 108 to support the rotating table 41. Chassis views and dimension shown on FIG. 50
II. Step Motor 42 to rotate the rotary table 41 and place the selected bin 40 exactly below discharge hatch/gate 43 of receiver container 25. Step motor 42 has four holes 110 (5.1 mm dia.) for connection of motor to machine back plate/body 14 though a support/bracket 116 by bolts 114 and nuts 115. Ground connection 109 have been considered for step motor as well. FIG. 51 shows step motor views and dimensions. FIG. 51a shows step motor specification.
III. Rotating Table/Plate 41 (Plastic Bins 40 Holder, 550 mm Dia. round plate) attached to step motor shaft. A bush (shaft bush) 46 attached to center of rotating table 41. The rotating table 41 fixed on strengthen plate (Plastic/ABS strengthen plate) 44 by screws 111 to handle the plastic bins load. Strengthen plate will be connected to base plate 107 by supporting legs 118 which the whole compartment sit on chassis 51. FIG. 52 shows rotating tables views and dimensions.
IV. Shaft 45 & shaft bush 46 to transfer the movement from step motor 42 to rotating table 41 through Pulleys 49/49a and belt 50. Shaft's bush 46 welded to rotating table plate 41 from outside. Shaft 45 will be fixed by shaft retainer 119 and setting screws 112 (8 mm dia.) within the bush and then pulley 49 will be connected at bottom to shaft. Another Pulley 49a has been connected with set screw 113 to Step Motor's shaft to transfer the movement from motor to rotating table. FIG. 53 shows pulleys view, dimensions and specification. Belt 50 width is 15 mm and shall be nylon covered or fiberglass reinforced with breaking strength of 315 N per mm and working tension of 712 N. Belt view and section shown on FIG. 54.
V. Plastic Bins 40 four [4] Nos. considered in current design but number of bins could be increased up to twelve based on the requirement for different defined materials. In current design the capacity of bins are big enough to store almost 0.12 m3 of recycled materials which could be equal up to 1.2 m3 of normal (not recycled) rubbish. Bins are Triangle shape and bins sizes are: 260 mm (L), 130 mm (H). FIG. 55 shows views and perspective of plastic bin.
VI. Supporting legs 118 for roller wheels 47 (plastic round ring with three wheels 117 attached to external surface of ring) & rotating table 41. This supporting legs 117 will connect the rotating tables to base plate 107 fixed on chassis 51 (Base plate 107 fixed on the chassis 51). FIG. 56 & FIG. 56a shows the full assembly details of recycled collection compartment.
VII. Waste collection compartment door 71: Access hinge door in front of machine (1000 mm (L)×200 mm (H)) for removing of filled plastic bins. By pressing of skip button 68e on control & display panel 68 will access to desired bins (Filled bins) to empty the full bins. Access door 71 has handle 145 for easy opening which attached to door by screw 148. Access door connected to machine bottom chassis 51 with hinge 146. A magnet 147 fixed on door to have firm closing of door. FIG. 71 show access door views and dimensions.

C—Disposal Compartment

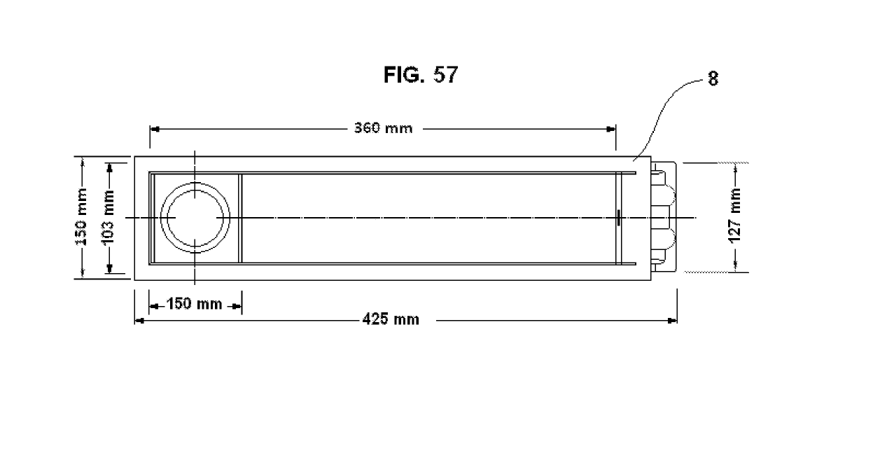

To dispose food scrapes and any other organic materials which include in our daily MSW, this compartment designed within the machine. Food Scraps is the major item in municipality solid wastes (MSW) and is almost 13.9% of Total US MSW (2010 Statistics). Food scraps include Bones, Seeds, Meat, Vegetables, Fruits, Dairy, Dry fruits, Chocolate, Sweets, Plants/Flowers, FOG (Fats, Oil, Grease) and Others. To recycle and dispose these items very efficiently, food disposal system/compartment within URDM machine designed with special features and includes following parts:
I. Stainless steel sink 8 (Size 150 mm (W)×400 mm (L)×50-150 mm (D) with attached items for feeding food scraps. FIG. 57 shows sink top view and dimensions.

### Sink Technical Specs:

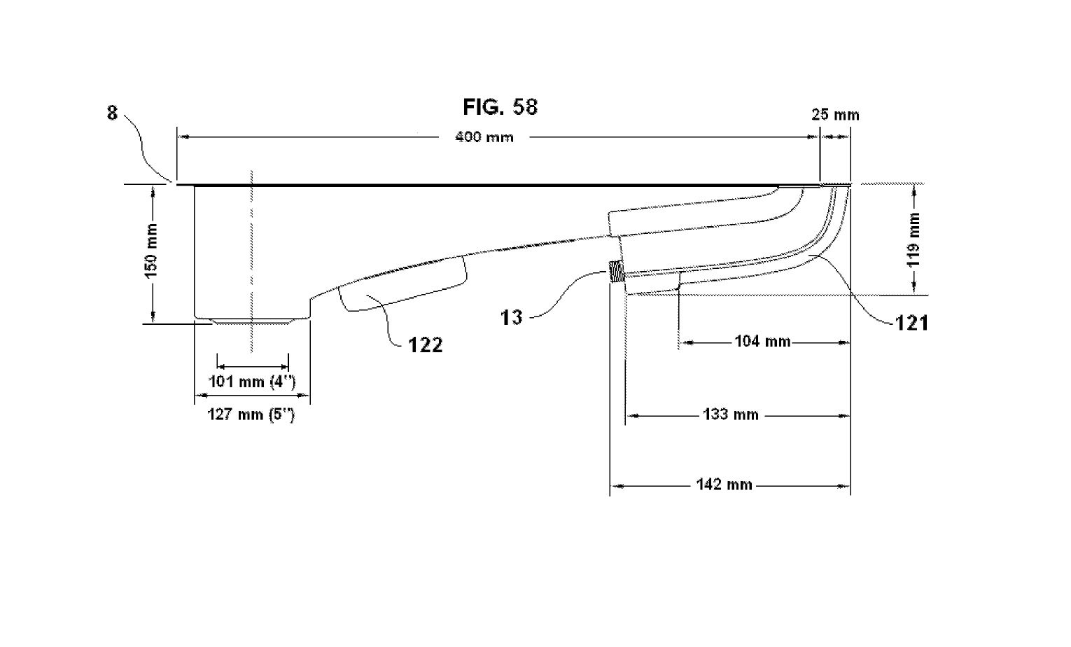

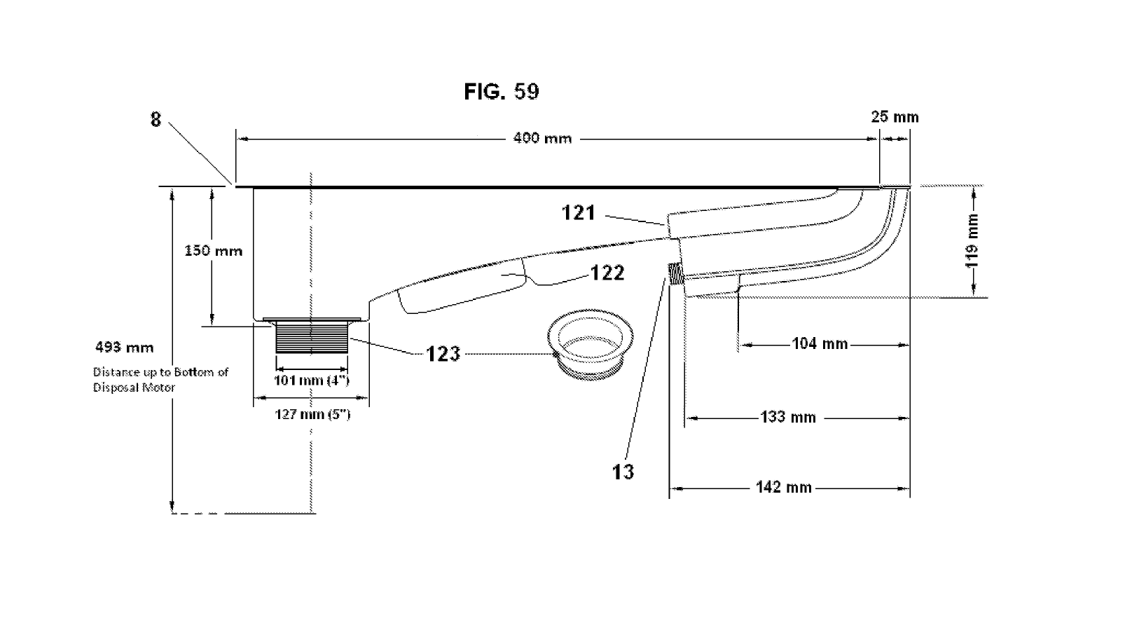

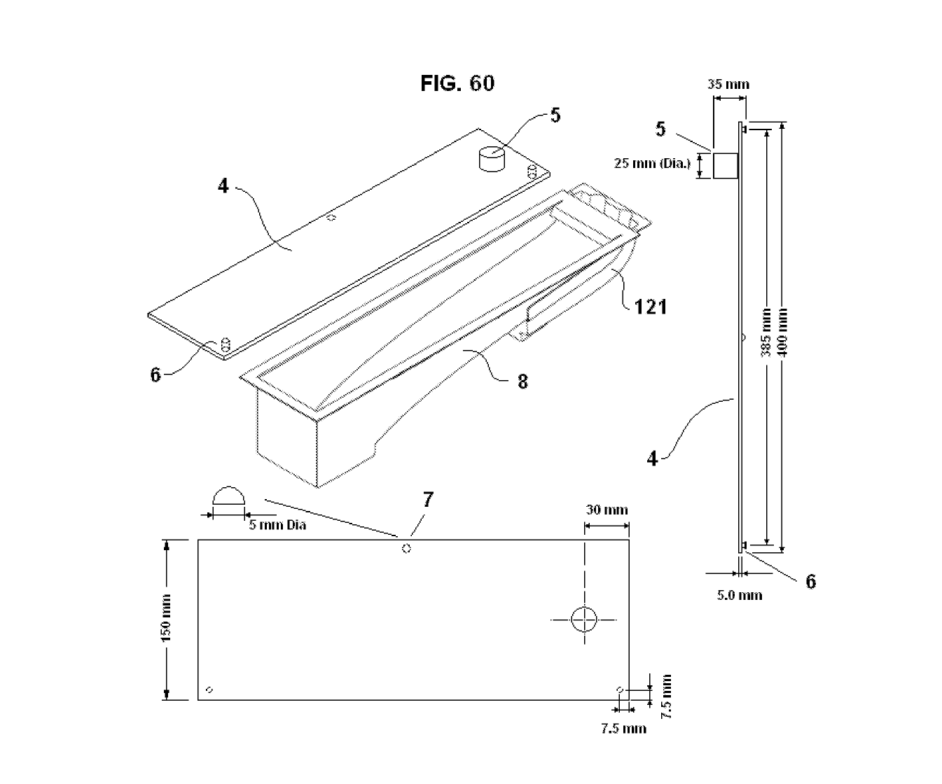

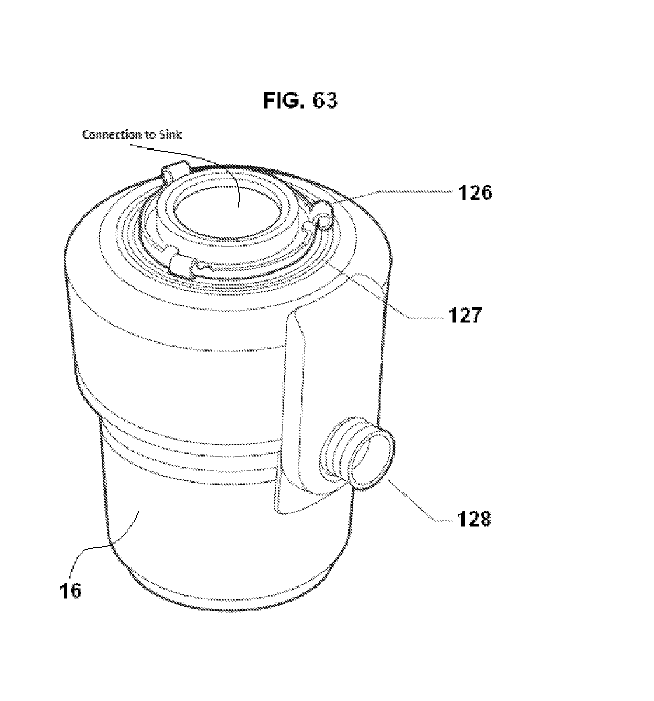

Stainless steel 16-gauge or equal material
Typical to a Under-mount sink
Sink 8 & water delivery section 121 integrated in a single compartment to have better efficiency and creating water fall effect on sink. FIG. 58 shows sink 8 (Side view) & water delivery section 121 integration.
Sink Size: 425 mm (L)×150 mm (W)
Cutlery saving magnet 122 attached to sink 8 to save the cutlery and protect the disposal motor 16 grinder & blades
Water Depth/Sink Depth: 150 mm
Drain Hole: Considered 4″ (101.8 mm). Sink flange 123 will connect the sink drain hole to disposal motor 16. FIG. 59 shows sink flange and assembly of flange to sink (Side view).
Separate circuit for disposal motor considered which will be protected with a Class A Ground-Fault Circuit-Interrupter (GFCI).
   II. Glass sliding door 4 (tempered glass) to cover the sink 8 when disposal motor 16 start to work and can be used as cutting board as well. A metal/plastic knob 5 for easy movement of door, metal T pins 6 which guide the door on grooves better and metal/rubber round pin 7 for balancing of door also attached to glass sliding door 4. FIG. 60 shows glass sliding door 4 views/dimensions and sink 8 perspective. FIG. 61 shows details of groves on top panel 1 for easy guidance of metal pins 6 which attached to glass door 4.
   III. Water pipe connection 13 (12.7 mm/½″) which connect the sink 8 to water supply solenoid valve 11 through plastic pipe 10.
   IV. Food waste disposal motor 16 for grinding/disposal of food scraps to be connected at bottom of stainless steel sink 8 at drain point through a flange 123. Disposal motor operation and water flow will be synchronous rinsing to allow one-touch control of both. FIG. 63 shows a typical disposal motor with drainage connection 128.

### Disposal Technical Specs:

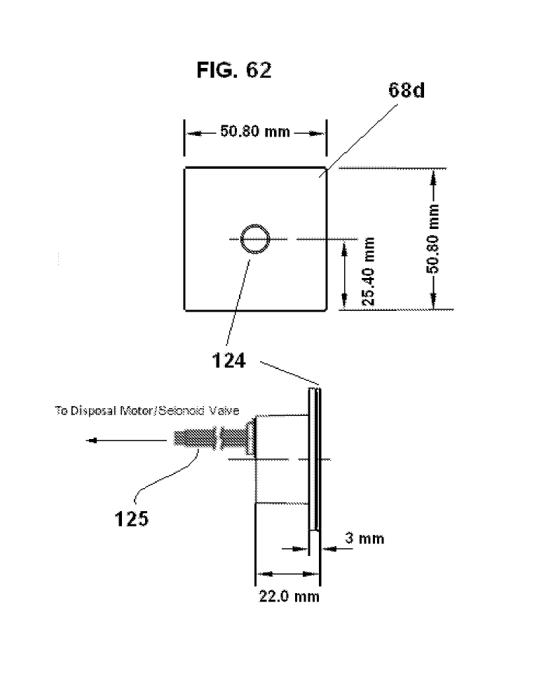

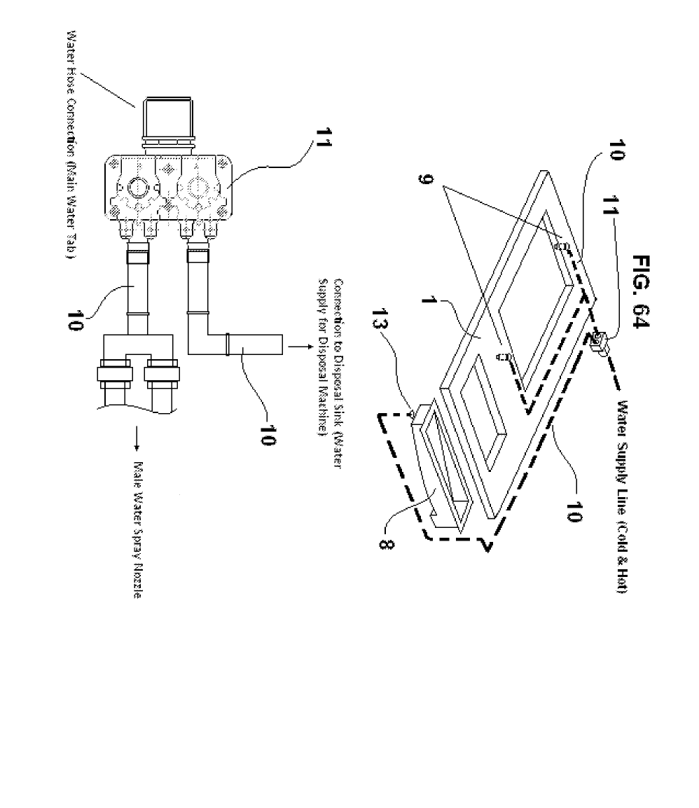

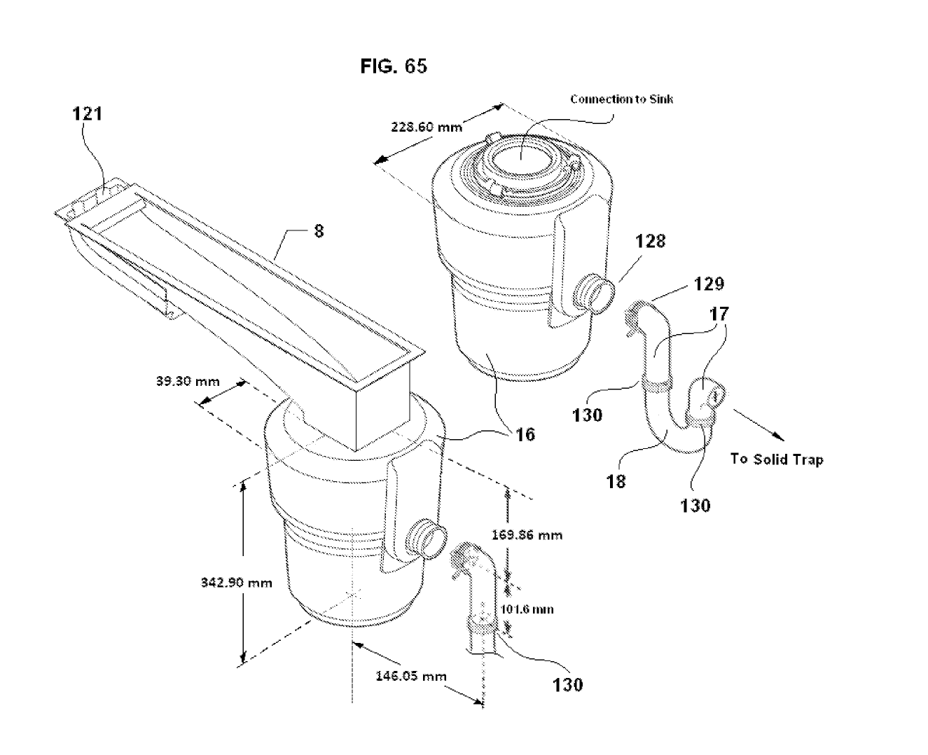

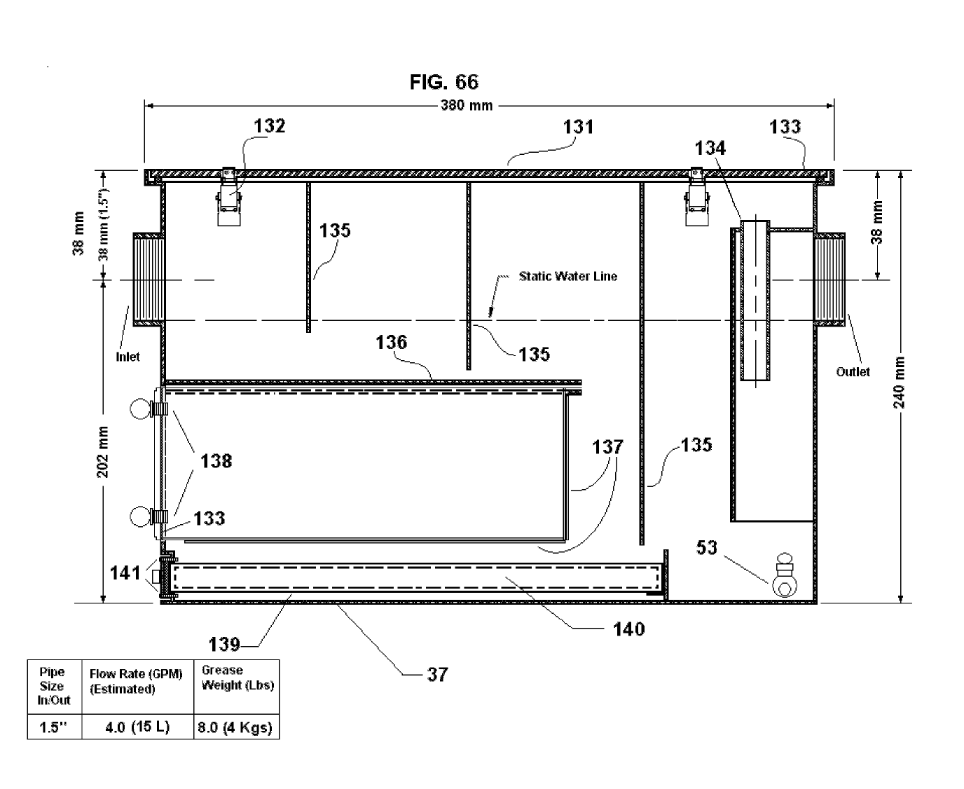

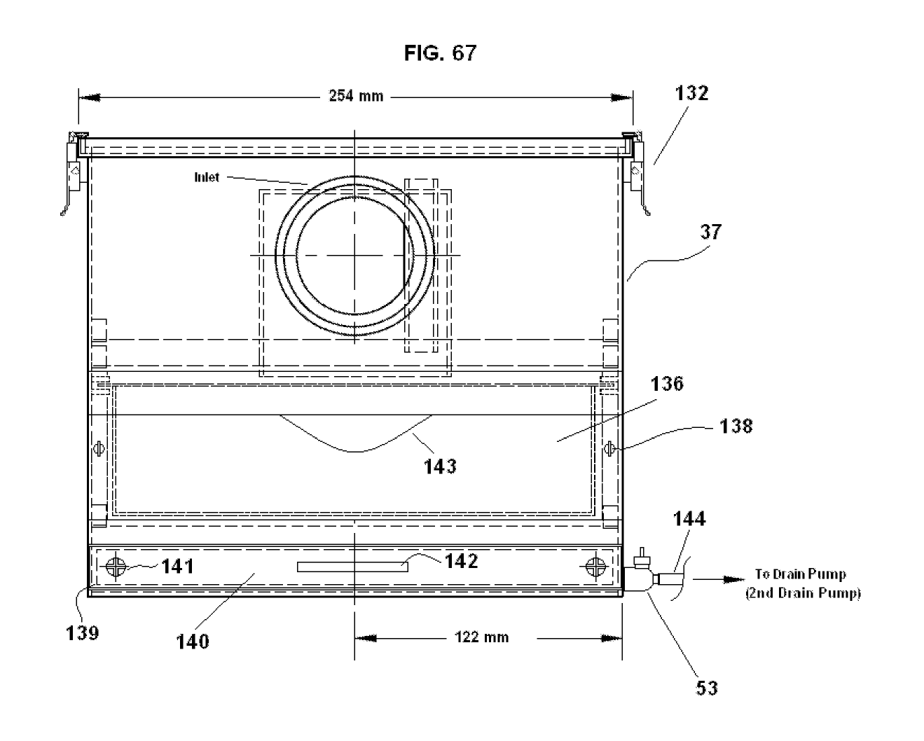

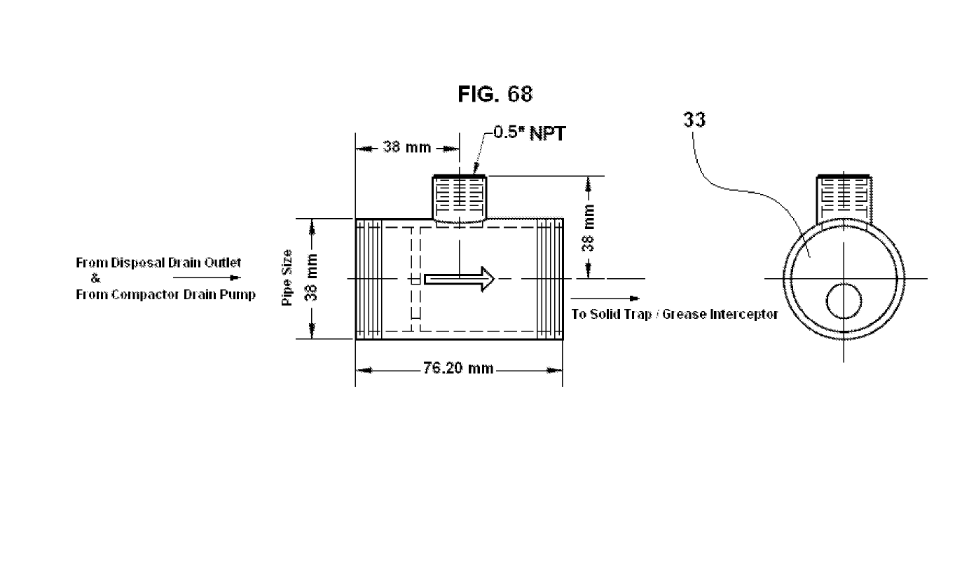

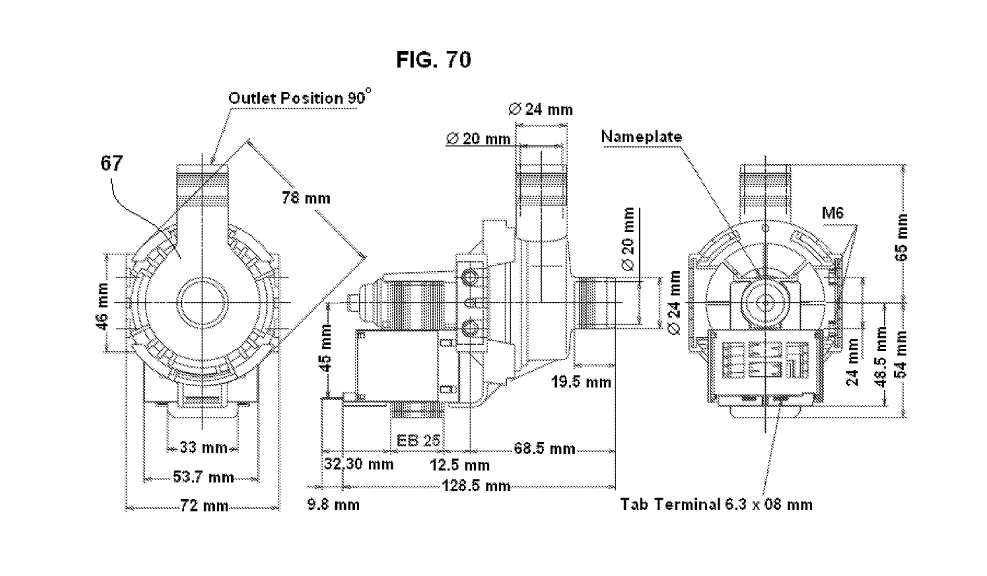

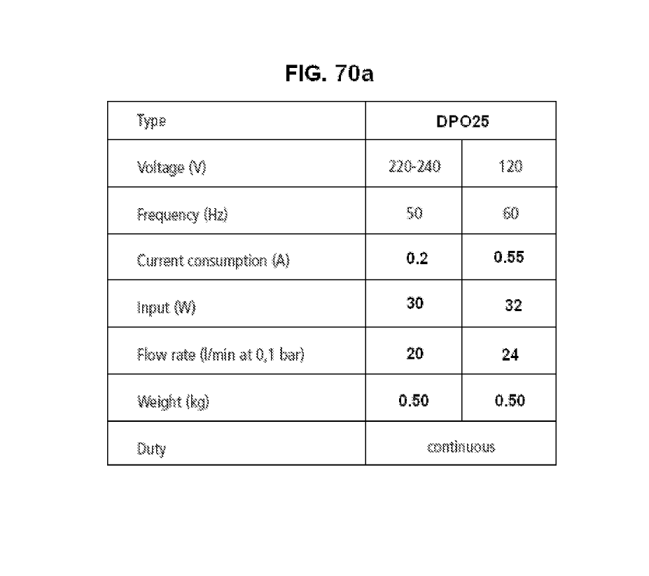

Nominal capacity: Approx. 40 to 50 kg/hr
Motor voltages: 1.0 hp, single phase, 0.55 kW, 230 v 50 hz
Motor control: Mounted on Front Machine panel,
Water connection: Cold or Hot & Cold supply to 15 mm (½″) pipe connector to Sink
Flow rate is around 12 liters per min.
Inlet pressure: Minimum of 0.3 bar
Waste connection: 1.5″ or 38 mm BSP outlet bend to waste, Anti-Vibration Connection have been considered (Typical Hose Clamp)
Motor: NEMA ULCSA Motor and is a Low Noise type also
Type of Feed: Continuous
Reversing: Considered Auto-Reverse Grind System
Lubrication: Permanently lubricated upper & lower bearings
Weight (Approx.): Less heavier motor is preferable but max weight considered around 10 to 11 Kg
Unit Finish: Stainless Steel
Overall Height: 343 mm, Total height with Sink is 493 mm according to design
Disposal Motor with multi layer sound insulation/seal (To minimize the sound) used in design. Anti-vibration mount 127 & lower mounting ring 126 also considered for the disposal motor.
Disposal motor with high efficiency grinding system which equipped with jam sensor considered to minimize the size of food scraps.
   V. Drainage connections from disposal motor tail pipe 128 to elbow drainage pipes 17 (2″/50 mm), U trap 18, flow control 33, solid trap/grease interceptor and finally to wall drainage inlet). Clamp & fittings 129 & 130 or pipe fastener considered for pipe connections. FIG. 65 shows the assembly details of disposal motor, sink and all drainage pipes and fittings.
   VI. On/Off switch 68d. Installed in control & display panel 68 and will synchronize the disposal motor 16 and solenoid valve 11 operation and work independently from recycling compartment. On/off switch 68d allow the easy control of disposal operation. On/off switch 68d will be connected by proper electrical wire 125 to disposal motor 16 and solenoid valve 11. LED light 124 attached to switch will show the on/off situation. FIG. 62 shows views of on/off switch.
   VII. Solid trap 37 (Within Grease Interceptor) with removable sliding solid strainer bucket 136 (perforated Baffle plate 137 with 9 mm dia. holes) to prevents solids from entering to the grease interceptor & city drainage pipe. Removable sliding solid strainer bucket 136 will allow easy waste removal from solid trap at any time. Body material will be stainless steel or plastic. Solid trap 37 equipped with gasketed cover 131 on top and sealing/securing metal clamps 132 (4 nos.) and gasket seal 133 fixed below the cover on trap body to seal the unit very efficiently. Sliding bucket 136 will be sealed firmly by plastic screws 138 to Solid trap body to avoid any leakage and have a handle 143 for easy moving and operation.
   VIII. Grease Interceptor/Trap 37 equipped with cartridge filter 139 and oil absorbent pillow 140 to prevent oil and grease entering to main drainage pipes and generally avoid any drain pipe blockage. Oil sunken in grease interceptor 37 by baffle plates 135 and to be absorbed by oil absorbent pillow 140 by simply removing of cartridge 139 which contain of these absorbent pillows from time to time. Water inside the grease Trap will be drained through a small valve 53 and drain pump 67 to drainage pipe before removing of cartridge and avoid spillage of water inside the machine during oil filter replacement. Cartridge filter 139 will be sealed firmly as well with screws 141 to solid trap/grease interceptor body and have a handle 142 for easy removing. Flow control 33 to be fixed between drain pipe outlet from disposal and solid trap/grease interceptor to control the water flow entry to grease interceptor. Body material will be stainless steel or plastic. FIG. 66 & FIG. 67 shows the side and front views/section of solid trap/grease interceptor 37. FIG. 68 shows flow control 33 views and dimensions.
   IX. Small drain pump & motor 67: To be connected to the valve 53 fixed on bottom of solid/grease trap 37 and to drain the water from solid/grease trap during cleaning of filter 136 or changing of oil absorbent pillows 140. Drainage diagram of machine FIG. 69 will show the complete connection of different parts in disposal compartment. FIG. 70 shows small drain pump 67 views and dimensions. FIG. 70a shows small drain pump specification.
   X. Electric (Solenoid) valve 11 to supply the water to sink 8 & disposal motor 16 during disposing process by On/Off switch 68d on main panel of machine. FIG. 64 shows water supply diagram to sink and disposal motor.
   XI. Front access door 71: For checking and emptying of solid trap filter and changing of grease Interceptor oil absorbent filter. FIG. 71 shows door views and dimension.

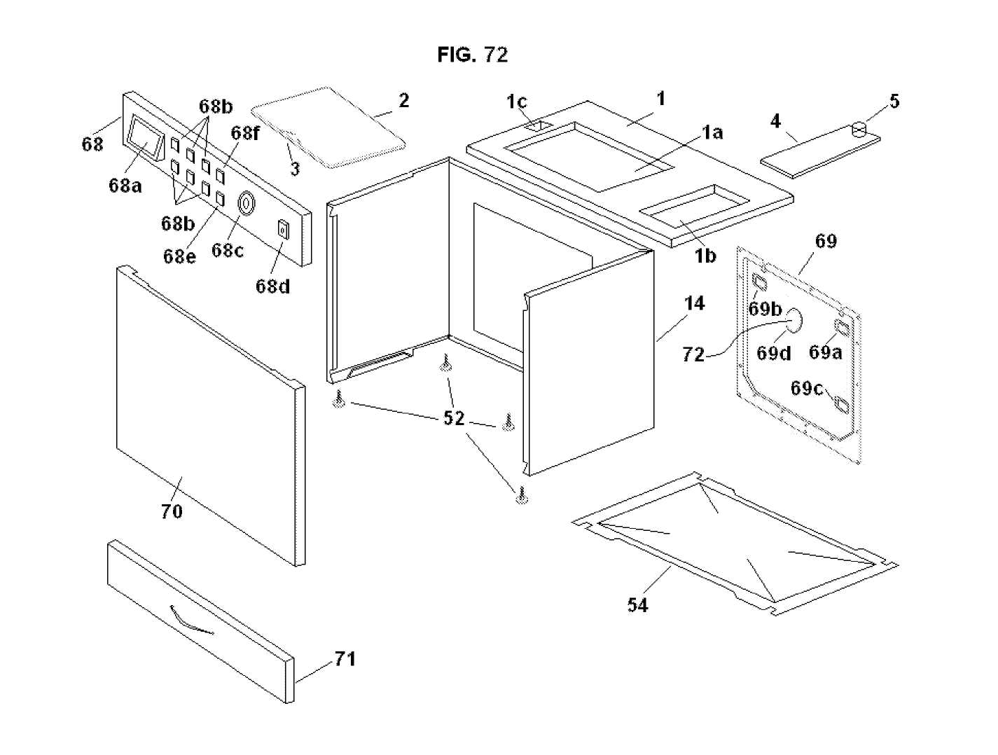

### FIG. 72

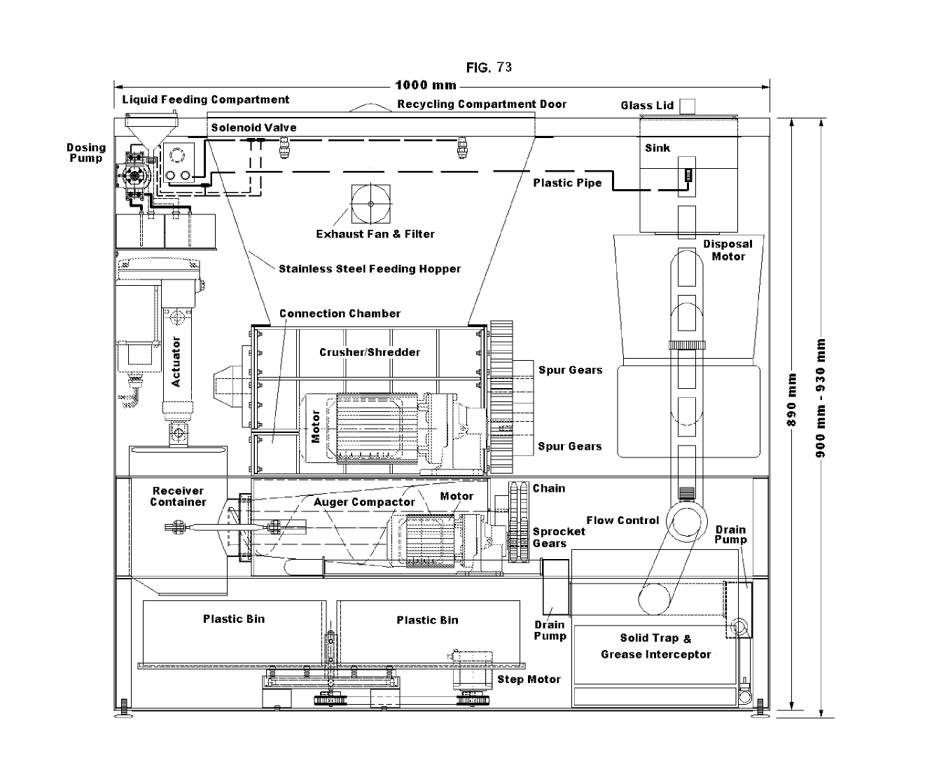

Machine body & front control panel design FIG. 72: Machine body & structure perspective/exploded view for covering external surface of machine which could be built from brushed stainless steel or painted steel 1.2 mm thickness, with dimensions of 1000 mm (L)×600 mm (W)×870 mm (H) and total height with legs 900 mm FIG. 73. This is only a conceptual design and drawing to show how the machine exterior looks and not with exact size, dimension and parts. Machine body shall include recycling compartment door 1, control & display panel 68.

This panel controls the operation of machine and includes LED Display 6″ (To display the program and to be used for instruction manual demo and training)(Could be attached to a camera which installed in hopper to show the crushing process) 68a, Program control buttons (Metal, Plastic, Glass, Paper, Wood, etc.) 68b for recycling of any desired materials, Timer (Recycling, Compaction, Washing & Rinse process control, with Cold & Hot Water option rinse) 68c to control the process with assigning of required time to each process related to selected material for better result and energy saving, On/Off buttons for Disposal compartment & Solenoid Valve operation 68d which start and stop both motor and valve operation, Recycled Collection Bins Skip Button (To rotate the rotary table and bring the desired bins in front for easy access and discharging of bin) 68e,

Solid/Grease Trap water draining buttons (For cleaning of bucket, changing of oil filter or cleaning of Solid/Grease Trap) 68f, Top Panel 1 (With 3 openings for Recycling 1a, Liquid Feeding 1c & Disposal Compartments 1b), Glass Sliding Door/Lid 4 for Disposal Compartment (to cover the sink when disposal does not work or in use and as a cutting board during disposing process), Knob (Metal/Plastic) 5 fixed on Glass lid 4 for ease of opening and closing of lid, Back Panel 69 with openings for electrical wires 69a, Water Pipe Connection (Solenoid Valve water pipe connection) 69b, Drainage Pipes 69c, Ventilation (Exhaust Pipe Connection) 69d, Machine's side & back Body 14 (1.2 mm Steel Plate), Front Panel 70 (Steel Plate 1.2 mm), Recycling collection compartment door 71, Bottom Panel 72 to close the bottom portion of machine and avoid of noise penetration to outside, Machine Legs 52 (Adjustable Screw Legs) to adjust the machine height and leveling of machine on the floor.

### FIG. 73

Machine Front View (Front Elevation with Main Parts Name & Detail) Front Elevation drawing with machine external dimensions including main parts' names and details.

1-5. (canceled)

6. A method of recycling materials comprising:
shredding said materials in a shredding compartment, said shredding compartment comprising rotary blades;
feeding said materials into a compactor chamber and compacting said materials using an auger;
feeding said materials into a receiving chamber; and
compacting said materials with an actuated disk and discharging said materials to a collection bin.

7. The method of claim 6, wherein said rotary blades comprise two parallel cylinders having interwoven blades, said blades operable to rotate in opposite directions to cause said material to be drawn therebetween.

8. The method of claim 6, wherein compactor chamber has a tapered, conical shape and said auger has a conical shape conforming to said compactor chamber.

9. The method of claim 8, wherein turning of said auger causes said material to progress through said compactor chamber.

10. The method of claim 9, wherein said tapered shape of said compactor chamber causes liquid from said material to drain from the compactor chamber.

11. The method of claim 6, further comprising a step of drawing water from said material and out of said system using a pump.

12. The method of claim 11, wherein said pump is coupled to said receiving chamber.

13. The method of claim 12, wherein said actuated disk comprises holes for passage of liquid therethrough as said material is compacted.

14. The method of claim 6, further comprising a step a facilitating a user-selection of particular steps to be carried out.

15. A system for recycling material comprising:
a shredder having two, interwoven rotary blades for shredding said material;
a compactor auger chamber having a tapered, conical cross-section with a corresponding tapered, conical auger rotatably disposed therein;
a compactor disk chamber having an actuated disk for compacting and discharging said material from said system; and
a pump for drawing liquid from said material and out of said system.

16. The system of claim 12, wherein said pump is coupled to said compactor disk chamber.
